(19) United States
(12) Patent Application Publication
(10) Pub. No.: US 2024/0371144 A1
(43) Pub. Date: Nov. 7, 2024

(54) MULTIMEDIA DATA PROCESSING METHOD AND APPARATUS, DEVICE, AND STORAGE MEDIUM

(71) Applicant: Tencent Technology (Shenzhen) Company Limited, Shenzhen (CN)

(72) Inventor: Binxu ZHAI, Shenzhen (CN)

(21) Appl. No.: 18/773,398

(22) Filed: Jul. 15, 2024

Related U.S. Application Data
(63) Continuation of application No. PCT/CN2023/123320, filed on Oct. 8, 2023.

(30) Foreign Application Priority Data
Oct. 8, 2022 (CN) 202211221506.6

(51) Int. Cl. G06V 10/776; G06V 10/40; G06V 10/764; G06V 10/774; G06V 10/82

(52) U.S. Cl. CPC G06V 10/776; G06V 10/40; G06V 10/764; G06V 10/774; G06V 10/82

(57) ABSTRACT

Embodiments of this application disclose a multimedia data processing method performed by a computer device. The method includes: obtaining sample multimedia data, and a labeled object type and a labeled object attribute of a sample object in the sample multimedia data; predicting an object type and an object attribute of the sample object by applying the sample multimedia data to an initial multimedia recognition model; adjusting the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute of an object in target multimedia data. According to this application, media recognition accuracy of a multimedia recognition model can be improved.

### CROSS-REFERENCE TO RELATED APPLICATIONS

This application is a continuation application of PCT Patent Application No. PCT/CN2023/123320, entitled “MULTIMEDIA DATA PROCESSING METHOD AND APPARATUS, DEVICE, AND STORAGE MEDIUM” filed on Oct. 8, 2023, which claims priority to Chinese Patent Application No. 202211221506.6, entitled “MULTIMEDIA DATA PROCESSING METHOD AND APPARATUS, DEVICE, AND STORAGE MEDIUM” filed on Oct. 8, 2022, both of which are incorporated by reference in their entirety.

### FIELD OF THE TECHNOLOGY

This application relates to the fields of cloud technologies, artificial intelligence technologies, and the like, and in particular, to a multimedia data processing method and apparatus, a device, and a storage medium.

### BACKGROUND OF THE DISCLOSURE

With rapid development of Internet technologies, multimedia recognition models configured for recognizing object features (such as object types or object attributes) of objects in multimedia data emerge. For example, in a multimedia platform, a multimedia recognition model may be used to recognize an object type corresponding to an object in an image, recognize a position of the object in the image, and set a label for the image based on object feature information such as the object type and the position of the object in the image, to enable a user to quickly retrieve a required image. In practice, it is found that when a same multimedia recognition model needs to complete a plurality of recognition tasks, a seesaw phenomenon easily occurs in the multimedia recognition model. For example, an improvement of a recognition effect of one recognition task leads to a decrease in a recognition effect of another recognition task.

### SUMMARY

Embodiments of this application provide a multimedia data processing method and apparatus, a device, and a storage medium, and can improve media recognition accuracy of a multimedia recognition model.

According to an aspect of the embodiments of this application, a multimedia data processing method is provided, including:
obtaining sample multimedia data, and a labeled object type and a labeled object attribute of a sample object in the sample multimedia data;
predicting an object type and an object attribute of the sample object by applying the sample multimedia data to an initial multimedia recognition model; and
adjusting the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute that are of an object in target multimedia data.

According to an aspect of the embodiments of this application, a computer device is provided, including a memory and a processor. When memory has a computer program stored therein, and the processor, when executing the computer program, causes the computer device to implement operations of the described method.

According to an aspect of the embodiments of this application, a non-transitory computer-readable storage medium is provided, having a computer program stored therein. The computer program, when being executed by a processor, implements operations of the described method.

According to an aspect of the embodiments of this application, a computer program product is provided, including a computer program. The computer program, when being executed by a processor, implements operations of the described method.

In the embodiments of this application, in a process of training the initial multimedia recognition model, the object-type prediction deviation and the object-attribute prediction deviation that are of the initial multimedia recognition model are introduced, and the initial object type is corrected based on the object-type recognition deviation, to obtain the predicted object type of the sample object. In this way, accuracy of the object type predicted by the initial multimedia recognition model can be improved, to help improve a difference degree between object types of different sample objects. The initial object attribute is corrected based on the object-attribute prediction deviation, to obtain the predicted object attribute of the sample object. In this way, accuracy of the object attribute predicted by the initial multimedia recognition model can be improved, to help improve a difference degree between object attributes of different sample objects. Further, the initial multimedia recognition model is adjusted based on the predicted object type, the predicted object attribute, the labeled object type, and the labeled object attribute, to obtain the target multimedia recognition model configured for recognizing the target object type and the target object attribute that are of the object in the target multimedia data. In other words, when the initial multimedia recognition model is trained to fit the labeled object type and the labeled object attribute that are of the sample object, the prediction errors of the initial multimedia recognition model for the two types of tasks are reduced, to avoid a seesaw phenomenon occurred in the initial multimedia recognition model, and improve media recognition accuracy and a generalization capability of the multimedia recognition model. In addition, during training, a loss function and a prediction branch in the initial/target multimedia recognition model require a small model computing amount and small time consumption, so that a computing resource for model training can be saved.

### BRIEF DESCRIPTION OF THE DRAWINGS

To describe the technical solutions in embodiments of this application or the related art more clearly, the accompanying drawings required for describing the embodiments or the related art are briefly described below. It is clear that the accompanying drawings in the following descriptions are merely some embodiments of this application, and a person of ordinary skill in the art may further derive other drawings based on the accompanying drawings without creative efforts.

FIG. 1 is a schematic diagram of a multimedia data processing system according to this application.

FIG. 2 is a schematic diagram of an interaction scenario between devices in a multimedia data processing system according to this application.

FIG. 3 is a schematic diagram of an interaction scenario between devices in a multimedia data processing system according to this application.

FIG. 4A is a schematic flowchart of a multimedia data processing method according to this application.

FIG. 4B is a schematic flowchart of another multimedia data processing method according to this application.

FIG. 5 is a schematic flowchart of still another multimedia data processing method according to this application.

FIG. 6 is a schematic diagram of a scenario in which a target multimedia recognition model recognizes a brand type and a brand location in target multimedia data according to this application.

FIG. 7 is a schematic diagram of a structure of a multimedia data processing apparatus according to an embodiment of this application.

FIG. 8 is a schematic diagram of a structure of a computer device according to an embodiment of this application.

### DESCRIPTION OF EMBODIMENTS

The technical solutions in embodiments of this application are clearly and completely described below with reference to the accompanying drawings of the embodiments of this application. It is clear that the described embodiments are a part of the embodiments of this application, rather than all of the embodiments. Based on the embodiments of this application, all other embodiments obtained by a person of ordinary skill in the art without creative efforts shall fall within the protection scope of this application.

This application mainly relates to artificial intelligence technologies. Artificial intelligence (AI) is a theory, a method, a technology, and an application system that use a digital computer or a machine controlled by the digital computer to simulate, extend, and expand human intelligence, perceive an environment, obtain knowledge, and use the knowledge to obtain an optimal result. In other words, the artificial intelligence is a comprehensive technology of computer science, to attempt to understand an essence of intelligence, and produce a new intelligent machine that can react in a manner similar to that of human intelligence. The artificial intelligence is to study a design principle and an implementation method of various intelligent machines, to enable the machines to have functions of perception, inference, and decision-making. The artificial intelligence technologies are a comprehensive discipline, and relate to a wide range of fields, including both hardware-level technologies and software-level technologies. Basic technologies of the artificial intelligence usually include technologies such as a sensor, a dedicated artificial intelligence chip, cloud computing, distributed storage, big data processing technologies, an operating/interaction system, and mechatronics. Artificial intelligence software technologies mainly include several directions such as computer vision technologies, voice processing technologies, nature language processing technologies, and machine learning/deep learning.

The machine learning (ML) is a discipline in which a plurality of fields intersect, and relates to a plurality of disciplines such as the probability theory, statistics, the approximation theory, convex analysis, and the computational complexity theory. In the machine learning, how a computer simulates or implements a human learning behavior is specifically studied, to obtain new knowledge or a new skill, and reorganize an existing knowledge structure, so that performance of the computer is continuously improved. The machine learning is a core of the artificial intelligence, a basic manner to make a computer intelligent, and is applied to various fields of the artificial intelligence. The machine learning and the deep learning usually include technologies such as an artificial neural network, a belief network, reinforcement learning, transfer learning, inductive learning, and teaching learning.

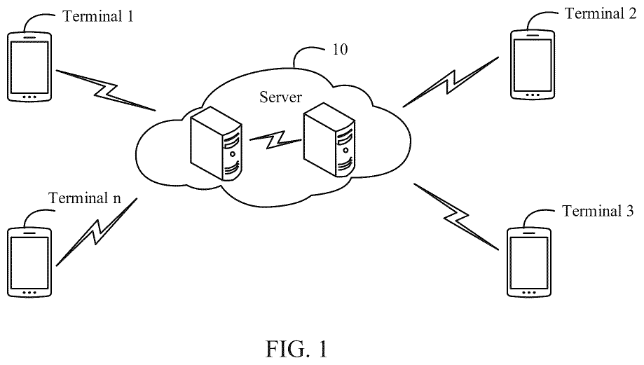

For clearer understanding of this application, a multimedia data processing system that implements a multimedia data processing method of this application is first described. As shown in FIG. 1, the multimedia data processing system includes a server 10 and a terminal cluster. The terminal cluster may include one or more terminals. A quantity of terminals is not limited herein. As shown in FIG. 1, the terminal cluster may specifically include a terminal 1, a terminal 2, . . . , and a terminal n. The terminal 1, the terminal 2, the terminal 3, . . . , and the terminal n may all be in a network connection with the server 10, so that each terminal can exchange data with the server 10 through the network connection.

For example, a multimedia platform for providing multimedia data to a user is installed on the terminal. The multimedia platform may include, but is not limited to, a game application download platform, a short video platform, a content publishing platform, an audio and video play platform, a shopping platform, and the like. The multimedia platform in the terminal may be for uploading the multimedia data, playing the multimedia data, and the like.

The multimedia data refers to different specific content in different multimedia platforms. For example, in the game application download platform, the multimedia data may refer to a game application, such as a single-player game, a network game, a mobile game, or a mini game. In the short video platform, the multimedia data may refer to a segment of video or a frame of image. In the audio and video play platform, the multimedia data may refer to a video work, audio data, or the like. In the shopping platform, the multimedia data may refer to a product or service sold in the shopping platform. In the content publishing platform, the multimedia data may refer to a literary work, news, a travel note, or the like.

The server may be a device that provides a backend service for the multimedia platform. For example, the server may be configured to audit the multimedia data uploaded by the user to the multimedia platform. The server in this embodiment of this application may be further configured to train a multimedia recognition model configured for recognizing an object type and an object attribute that are of an object in the multimedia data, classifying the multimedia data based on the object type and the object attribute, or recommending the multimedia data to the user based on the object type and the object attribute.

In this embodiment of this application, one multimedia recognition model may be for completing a plurality of recognition tasks. In other words, the multimedia recognition model may be referred to as a multi-task based multimedia recognition model. For example, the multimedia recognition model may be configured for recognizing the object type of the object in the multimedia data (that is, a type recognition task), and recognizing the object attribute of the object in the multimedia data (that is, an attribute recognition task). The object type may refer to a coarse feature of the object in the multimedia data, and the object attribute may refer to a detailed feature of the object in the multimedia data. Alternatively, the object type may refer to a feature belonging to the object in the multimedia data and having a discrete distribution feature, and the object attribute may refer to a feature belonging to the object in the multimedia data and having a continuous distribution feature. For example, when the object is an animal in the multimedia data, the object type refers to a type of the animal, such as a cat or a dog, and the object attribute refers to a size, a location, and the like of the animal. The object type may be represented by using a type ID. The type ID is an integer value and a discrete enumeration value. For example, 0, 1, and 2 represent three types respectively. For example, the object attribute may be a location that is of the object in the multimedia data (a picture) and that is represented by using coordinates of four vertexes of a bounding box covering the object. The object attribute may be continuous values between 0 and N, where N may represent a maximum size of the picture for object detection. In this embodiment of this application, a multimedia recognition model before training is referred to as an initial multimedia recognition model, and a multimedia recognition model after the training is referred to as a target multimedia recognition model.

The server may be an independent physical server, a server cluster or distributed system including at least two physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal may specifically refer to a vehicle-mounted terminal, a smartphone, a tablet computer, a notebook computer, a desktop computer, a smart speaker, a screen speaker, a smart watch, or the like, but is not limited thereto. Each terminal may be directly or indirectly connected to the server in a wired or wireless communication manner. In addition, a quantity of terminals and a quantity of servers each may be one or at least two. This is not limited in this application.

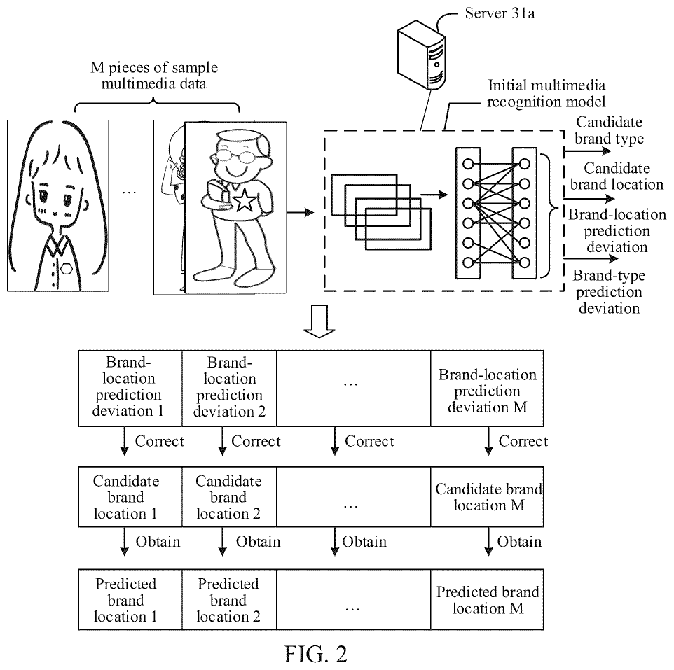

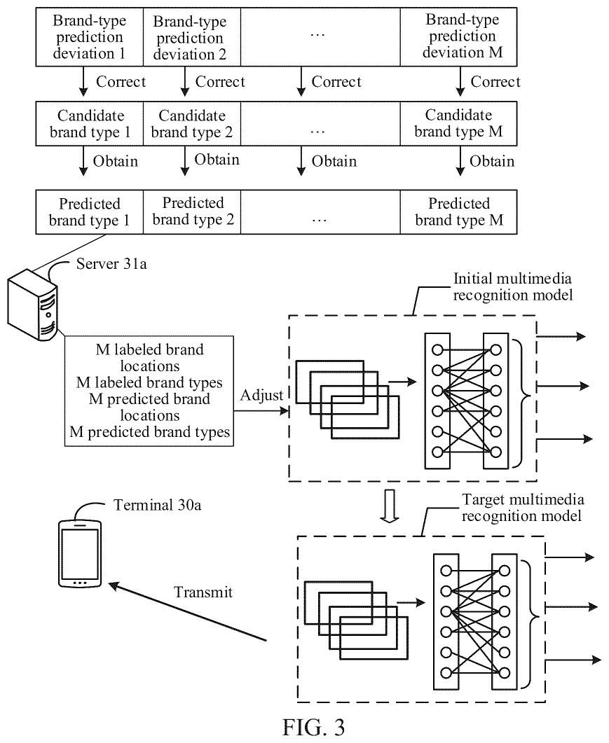

Based on the foregoing multimedia data processing system, the multimedia data processing method in the embodiments of this application can be implemented. The multimedia data processing method includes a training process of an initial multimedia recognition model. As shown in FIG. 2 and FIG. 3, training of a multimedia recognition model configured for recognizing a brand type and a brand location in multimedia data is used as an example for description. A terminal 30a in FIG. 3 may refer to any terminal in the terminal cluster in FIG. 1, and a server 31a in FIG. 2 and FIG. 3 may refer to the server 10 in FIG. 1. As shown in FIG. 2 and FIG. 3, the training process of the initial multimedia recognition model includes the following operations S21 to S26.

S21: The server 31a obtains a training data set. The training data set includes a plurality of pieces of sample multimedia data, and a labeled brand type and a labeled brand location in each piece of sample multimedia data. A quantity of pieces of sample multimedia data is M, and M is an integer greater than or equal to 1. The labeled brand type may be, for example, a real brand type in the sample multimedia data. A quantity of types in the labeled brand type may be K, and K is an integer greater than or equal to 1. The labeled brand location may be, for example, a real position (such as coordinates) of a brand logo in the sample multimedia data. The labeled brand type and the labeled brand location may be obtained by manually labeling the sample multimedia data.

S22: Obtain, by using an initial multimedia recognition model, brand types respectively included in the M pieces of sample multimedia data, and brand-type prediction deviations of the initial multimedia recognition model respectively for the M pieces of sample multimedia data. For example, the server 31a inputs sample multimedia data 1 in the training data set into the initial multimedia recognition model. A brand type in the sample multimedia data 1 is predicted/recognized by using the initial multimedia recognition model, to obtain a candidate brand type 1 included in the sample multimedia data 1, and a brand-type prediction deviation 1 of the initial multimedia recognition model for the sample multimedia data 1. The brand-type prediction deviation 1 herein is configured for reflecting uncertainty of prediction performed by the initial multimedia recognition model for the brand type included in the sample multimedia data 1. The brand-type prediction deviation 1 may alternatively be configured for reflecting a deviation between the candidate brand type outputted by the initial multimedia recognition model and the labeled brand type. Similarly, sample multimedia data 2 in the training data set is inputted into the initial multimedia recognition model. A brand type in the sample multimedia data 2 is predicted/recognized by using the initial multimedia recognition model, to obtain a candidate brand type 2 included in the sample multimedia data 2, and a brand-type prediction deviation 2 of the initial multimedia recognition model for the sample multimedia data 2. The brand-type prediction deviation 2 herein is configured for reflecting uncertainty of prediction performed by the initial multimedia recognition model for the brand type in the sample multimedia data 2. The brand-type prediction deviation 2 may alternatively be configured for reflecting a deviation between the candidate brand type outputted by the initial multimedia recognition model and the labeled brand type. A similar operation is performed until candidate brand types respectively included in the M pieces of sample multimedia data and the brand-type prediction deviations of the initial multimedia recognition model respectively for the M pieces of sample multimedia data are predicted/recognized.

S23: Obtain, by using the initial multimedia recognition model, brand locations corresponding to brands respectively included in the M pieces of sample multimedia data, and brand-location prediction deviations of the initial multimedia recognition model respectively for the M pieces of sample multimedia data. For example, the server 31a inputs the sample multimedia data 1 in the training data set into the initial multimedia recognition model. A brand location in the sample multimedia data 1 is predicted/recognized by using the initial multimedia recognition model, to obtain a candidate brand location 1 corresponding to a brand included in the sample multimedia data 1, and a brand-location prediction deviation 1 of the initial multimedia recognition model for the sample multimedia data 1. The brand-location prediction deviation 1 herein is configured for reflecting uncertainty of prediction performed by the initial multimedia recognition model for the brand location corresponding to the brand included in the sample multimedia data 1. The brand-location prediction deviation 1 may alternatively be configured for reflecting a deviation between the candidate brand location outputted by the initial multimedia recognition model and the labeled brand location. Similarly, the sample multimedia data 2 in the training data set is inputted into the initial multimedia recognition model. A brand location in the sample multimedia data 2 is predicted/recognized by using the initial multimedia recognition model, to obtain a candidate brand location 2 corresponding to a brand included in the sample multimedia data 2, and a brand-location prediction deviation 2 of the initial multimedia recognition model for the sample multimedia data 2. The brand-location prediction deviation 2 herein is configured for reflecting uncertainty of prediction performed by the initial multimedia recognition model for the brand location in the sample multimedia data 2. The brand-location prediction deviation 2 may alternatively be configured for reflecting a deviation between the candidate brand location outputted by the initial multimedia recognition model and the labeled brand location. A similar operation is performed until candidate brand locations corresponding to the brands respectively included in the M pieces of sample multimedia data and the brand-location prediction deviations of the initial multimedia recognition model respectively for the M pieces of sample multimedia data are predicted/recognized.

S24: The server 31a may obtain predicted brand types respectively corresponding to the M pieces of sample multimedia data and predicted brand locations respectively corresponding to the M pieces of sample multimedia data. The server 31a may correct the candidate brand type 1 based on the brand-type prediction deviation 1, to obtain a predicted brand type of an object in the sample multimedia data 1, correct the candidate brand type 2 based on the brand-type prediction deviation 2, to obtain a predicted brand type of an object in the sample multimedia data 2, and so on, until the predicted brand types respectively corresponding to the M pieces of sample multimedia data are obtained. Similarly, the server 31a may correct the candidate brand location 1 based on the brand-location prediction deviation 1, to obtain a predicted brand location of the object in the sample multimedia data 1, correct the candidate brand location 2 based on the brand-location prediction deviation 2, to obtain a predicted brand location of the object in the sample multimedia data 2, and so on, until the predicted brand locations respectively corresponding to the M pieces of sample multimedia data are obtained.

S25: The server 31a may perform iterative training on the initial multimedia recognition model based on the predicted brand locations, the predicted brand types, the labeled brand types, and the labeled brand location that respectively correspond to the M pieces of sample multimedia data, until the initial multimedia recognition model is in a converged state, to obtain a target multimedia recognition model configured for recognizing a brand type and a brand location that correspond to target multimedia data.

S26: The server 31a may transmit the target multimedia recognition model to the terminal 30a. The terminal 30a may invoke the target multimedia recognition model to recognize the brand type in the target multimedia data, to obtain an initial brand type included in the target multimedia data, and a brand-type recognition deviation of the target multimedia recognition model for the target multimedia data; and invoke the target multimedia recognition model to perform brand-location recognition on the target multimedia data, to obtain an initial brand location of a brand included in the target multimedia data, and a brand-location recognition deviation of the target multimedia recognition model for the target multimedia data. A target brand type included in the target multimedia data is determined based on the brand-type recognition deviation and the initial brand type. A target brand location of the brand included in the target multimedia data is determined based on the brand-location recognition deviation and the initial brand location.

In conclusion, in the training process of the initial multimedia recognition model, the brand-type prediction deviation and the brand-location prediction deviation that are of the initial multimedia recognition model are introduced, and the initial brand type is corrected based on the brand-type prediction deviation, to obtain the predicted brand type. In this way, accuracy of the brand type predicted by the initial multimedia recognition model can be improved, to help improve a difference degree between different brand types. The initial brand location is corrected based on the brand-location prediction deviation, to obtain the predicted brand location. In this way, accuracy of the brand location predicted by the initial multimedia recognition model can be improved, to help improve a difference degree between different brand locations. Further, the initial multimedia recognition model is adjusted based on the predicted brand type, the predicted brand location, the labeled brand type, and the labeled brand location, to obtain the target multimedia recognition model configured for recognizing the brand type and the brand location that are of the brand in the target multimedia data. In other words, when the initial multimedia recognition model is trained to fit the labeled brand type and the labeled brand location, prediction errors of the initial multimedia recognition model for the two types of tasks are reduced, to improve media recognition accuracy and a generalization capability of the multimedia recognition model.

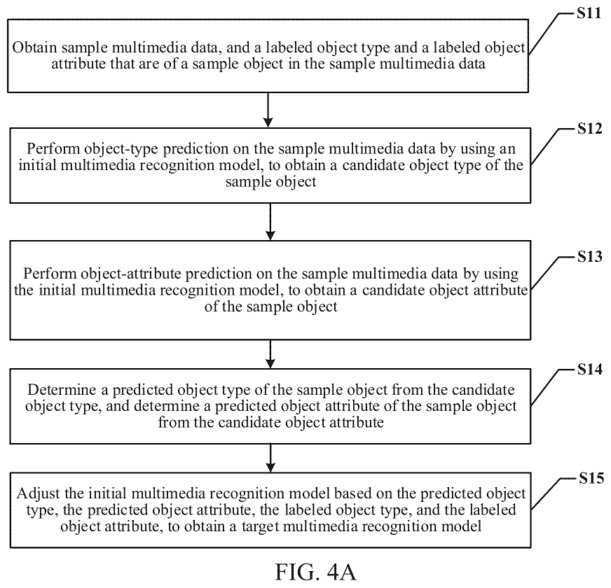

FIG. 4A is a schematic flowchart of a multimedia data processing method according to an embodiment of this application. As shown in FIG. 4A, the method may be performed by any terminal in the terminal cluster in FIG. 1, or may be performed by the server in FIG. 1. In this embodiment of this application, a device configured to perform the multimedia data processing method may be collectively referred to as a computer device. The method may include the following operations.

Operation S11: Obtain sample multimedia data, and a labeled object type and a labeled object attribute that are of a sample object in the sample multimedia data.

Operation S12: Perform object-type prediction on the sample multimedia data by using an initial multimedia recognition model, to obtain a candidate object type of the sample object.

Operation S13: Perform object-attribute prediction on the sample multimedia data by using the initial multimedia recognition model, to obtain a candidate object attribute of the sample object.

Operation S14: Determine a predicted object type of the sample object from the candidate object type, and determine a predicted object attribute of the sample object from the candidate object attribute.

Operation S15: Adjust the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute that are of an object in target multimedia data.

During execution of operations S12 and S13, the method may further include: determining an object-type prediction deviation of the initial multimedia recognition model for the sample multimedia data and an object-attribute prediction deviation of the initial multimedia recognition model for the sample multimedia data.

Operation S14 further includes: correcting the candidate object type based on the object-type prediction deviation, to obtain the predicted object type of the sample object, and correcting the candidate object attribute based on the object-attribute prediction deviation, to obtain the predicted object attribute of the sample object.

For detailed descriptions of operation S11, refer to the following descriptions of operation S101 in FIG. 4B. For detailed descriptions of operation S12, refer to the following descriptions of operation S102 in FIG. 4B. For detailed descriptions of operation S13, refer to the following descriptions of operation S103 in FIG. 4B. For detailed descriptions of operation S14, refer to the following descriptions of operation S104 in FIG. 4B. For detailed descriptions of operation S15, refer to the following descriptions of operation S105 in FIG. 4B.

Further, FIG. 4B is a schematic flowchart of a multimedia data processing method according to an embodiment of this application. As shown in FIG. 4B, the method may be performed by any terminal in the terminal cluster in FIG. 1, or may be performed by the server in FIG. 1. In this embodiment of this application, a device configured to perform the multimedia data processing method may be collectively referred to as a computer device. The method may include the following operations.

S101: Obtain sample multimedia data, and a labeled object type and a labeled object attribute that are of a sample object in the sample multimedia data.

In this embodiment of this application, the computer device may locally obtain the sample multimedia data or obtain the sample multimedia data from the Internet, and obtain the labeled object type and the labeled object attribute that are of the sample object in the sample multimedia data. The labeled object type may be a manually labeled object type (for example, may be a real object type of the sample object) of the sample object. The labeled object attribute may be a manually labeled object attribute (for example, may be a real object attribute of the sample object) of the sample object. When the sample multimedia data is image data or video data, the sample object may be a pattern, a person, an animal, or the like in the image data or the video data. The object type of the sample object may be a brand type to which the pattern belongs, a gender of the person, a type of the animal, or the like. The object attribute of the sample object may be at least one of a size or a location of the sample object in the image data or the video data. When the sample multimedia data may be text data, the sample object may be text content, the object type of the sample object may be a subject type of the text content, and the object attribute of the sample object may be a quantity of words included in the text content, a font size, or the like.

S102: Perform object-type prediction on the sample multimedia data by using an initial multimedia recognition model, to obtain a candidate object type of the sample object, and an object-type prediction deviation of the initial multimedia recognition model for the sample multimedia data.

In this embodiment of this application, the computer device may input the sample multimedia data into the initial multimedia recognition model, and perform object-type prediction on the sample multimedia data by using the initial multimedia recognition model, to obtain the candidate object type of the sample object, and the object-type prediction deviation of the initial multimedia recognition model for the sample multimedia data.

The candidate object type is an object type that is of the sample object and that is obtained by performing object-type prediction on the sample multimedia data by using the initial multimedia recognition model. The word “candidate” is for distinguishing the object type of this phase from an object type of another phase, and may be replaced by another word. For example, the “candidate object type” may also be referred to as a “first predicted object type” or a “preliminary predicted object type”.

The object-type prediction deviation is outputted by the initial multimedia recognition model. The object-type prediction deviation is obtained by the initial multimedia recognition model through learning based on historical sample multimedia data and the current sample multimedia data. The object-type prediction deviation belongs to a statistical parameter of the initial multimedia recognition model. The object-type prediction deviation is configured for reflecting uncertainty of object-type prediction performed by the initial multimedia recognition model for the sample multimedia data. The object-type prediction deviation may alternatively be configured for reflecting a deviation between the labeled object type and the candidate object type that is of the sample object and that is outputted by the initial multimedia recognition model.

S103: Perform object-attribute prediction on the sample multimedia data by using the initial multimedia recognition model, to obtain a candidate object attribute of the sample object, and an object-attribute prediction deviation of the initial multimedia recognition model for the sample multimedia data.

In this embodiment of this application, the computer device may perform object-attribute prediction on the sample multimedia data by using the initial multimedia recognition model, to obtain the candidate object attribute of the sample object, and the object-attribute prediction deviation of the initial multimedia recognition model for the sample multimedia data.

The candidate object attribute is an object attribute that is of the sample object and that is obtained by performing object-attribute prediction on the sample multimedia data by using the initial multimedia recognition model. The word “candidate” is for distinguishing the object attribute of this phase from an object attribute of another phase, and may be replaced by another word. For example, the “candidate object attribute” may also be referred to as a “first predicted object attribute” or a “preliminary predicted object attribute”.

The object-attribute prediction deviation herein is outputted by the initial multimedia recognition model. The object-attribute prediction deviation is obtained by the initial multimedia recognition model through learning based on the historical sample multimedia data and the current sample multimedia data. The object-attribute prediction deviation belongs to a statistical parameter of the initial multimedia recognition model. The object-attribute prediction deviation has randomness. The object-attribute prediction deviation is configured for reflecting uncertainty of object-attribute prediction performed by the initial multimedia recognition model for the sample multimedia data. The object-attribute prediction deviation may alternatively be configured for reflecting a deviation between the labeled object attribute and the candidate object attribute that is of the sample object and that is outputted by the initial multimedia recognition model.

Because the initial multimedia recognition model has randomness, both the object-attribute prediction deviation and the object-type prediction deviation have randomness. Object-attribute prediction deviations corresponding to different sample multimedia data may be different, and object-type prediction deviations corresponding to different sample multimedia data may also be different.

S104: Correct the candidate object type based on the object-type prediction deviation, to obtain a predicted object type of the sample object, and correct the candidate object attribute based on the object-attribute prediction deviation, to obtain a predicted object attribute of the sample object.

In this embodiment of this application, the initial multimedia recognition model performs object-type prediction on the sample multimedia data, and outputs K initial probabilities. The K initial probabilities are respectively configured for reflecting probabilities that the object type of the sample object in the sample multimedia data is respectively K candidate object types. The computer device may adjust, based on the object-type prediction deviation, initial probabilities (the K initial probabilities) respectively corresponding to the K candidate object types, to obtain target probabilities respectively corresponding to the K candidate object types, such as K target probabilities. The predicted object type of the sample object is determined based on the target probabilities respectively corresponding to the K candidate object types. For example, a candidate object type corresponding to a largest target probability in the K target probabilities is determined as the predicted object type of the sample object. The predicted object type is an object type obtained by correcting the candidate object type of the sample object based on the object-type prediction deviation. The “predicted object type” may also be referred to as a “second predicted object type”, a “final predicted object type”, or the like. The predicted object attribute is an object attribute obtained by correcting the candidate object attribute of the sample object based on the object-attribute prediction deviation. The “predicted object attribute” may also be referred to as a “second predicted object attribute”, a “final predicted object attribute”, or the like.

The candidate object type is corrected to obtain the predicted object type of the sample object, so that accuracy of the object type predicted by the multimedia recognition model can be improved, and a difference degree between predicted object types of different sample objects can be improved. Further, the computer device may correct the candidate object attribute based on the object-attribute prediction deviation, to obtain the predicted object attribute of the sample object. In this way, accuracy of the object attribute predicted by the multimedia recognition model can be improved, and a difference degree between predicted object attributes of different sample objects can be improved.

The foregoing correction processes of the candidate object type and the candidate object attribute may be implemented in either of the following two manners.

Manner 1: Directly correct the candidate object type based on the object-type prediction deviation, and directly correct the candidate object attribute based on the object-attribute prediction deviation. For example, the object-type prediction deviation reflects a usual deviation between a real probability and an initial probability of the candidate object type outputted by the initial multimedia recognition model. For example, the initial probability is usually greater than the real probability by a preset probability difference (for example, 0.2). In this case, the computer device may subtract the preset probability difference from initial probabilities respectively corresponding to the K candidate object types, to obtain the target probabilities respectively corresponding to the K candidate object types. The computer device determines the predicted object type of the sample object based on the target probabilities respectively corresponding to the K candidate object types. Similarly, the object-attribute prediction deviation reflects a usual deviation between the labeled object attribute and the candidate object attribute (for example, a size) outputted by the initial multimedia recognition model. For example, the candidate object attribute is usually less than the labeled object attribute by a preset value (for example, 0.5). In this case, the computer device may add the preset value to the candidate object attribute, to obtain the predicted object attribute of the sample object.

Manner 2: The computer device may determine a first distribution feature of the candidate object type and a second distribution feature of the candidate object attribute. The first distribution feature is configured for reflecting a distribution feature of the candidate object type, and the second distribution feature is configured for reflecting a distribution feature of the candidate object attribute. The first distribution feature may be a discrete distribution feature. The second distribution feature may be a discrete distribution feature or a continuous distribution feature. Further, a type deviation distribution function for describing the initial multimedia recognition model is determined based on the first distribution feature. The type deviation distribution function is for describing a distribution feature of the object-type prediction deviation of the initial multimedia recognition model. The candidate object type is corrected based on the type deviation distribution function, to obtain the predicted object type of the sample object. Then, an attribute deviation distribution function for describing the initial multimedia recognition model is determined based on the second distribution feature. The attribute deviation distribution function is for describing a distribution feature of the object-attribute prediction deviation of the initial multimedia recognition model. The candidate object attribute is corrected based on the attribute deviation distribution function, to obtain the predicted object attribute of the sample object.

If the first distribution feature indicates that the candidate object type has a discrete distribution feature, the computer device may use, as the type deviation distribution function of the initial multimedia recognition model, Boltzmann distribution in which a compliance parameter is used as a type prediction deviation, and adjust the candidate object type based on the Boltzmann distribution, to obtain the predicted object type of the sample object. The candidate object type may be a type ID, which is an integer value and a discrete enumeration value. For example, 0, 1, and 2 represent three types respectively. The computer device may first determine a ratio of an initial probability that the object type of the sample object is the candidate object type to the object-type prediction deviation, and perform exponentiation on the ratio, to obtain a candidate probability that the object type of the sample object is the candidate object type. Then, the computer device performs normalization processing on the candidate probability that the object type of the sample object is the candidate object type, to obtain a target probability that the object type of the sample object is the candidate object type. Finally, the computer device determines the predicted object type of the sample object based on the target probability that the object type of the sample object is the candidate object type. In particular, when the first distribution feature indicates that the candidate object type has the discrete distribution feature, the computer device may use, as the type deviation distribution function of the initial multimedia recognition model, another distribution function matching the discrete distribution feature. This is not limited in this application.

For example, for a candidate object type 1 of the sample object, the computer device may calculate a ratio of an initial probability corresponding to the candidate object type 1 to the object-type prediction deviation, to obtain a ratio 1. For example, the ratio 1 is n1. Then, the computer device calculates e to the power of n1, to obtain a candidate probability 1 that the object type of the sample object is the candidate object type 1, where e is 2.71828183. Similarly, for a candidate object type 2 of the sample object, the computer device may calculate a ratio of an initial probability corresponding to the candidate object type 2 to the object-type prediction deviation, to obtain a ratio 2. For example, the ratio 2 is n2. Then, the computer device calculates e to the power of n2, to obtain a candidate probability 2 that the object type of the sample object is the candidate object type 2. A similar operation is performed until candidate probabilities (K candidate probabilities in total, including the candidate probability 1, the candidate probability 2, . . . , and a candidate probability k) respectively corresponding to the K candidate object types are obtained. Normalization processing is performed on the candidate probability 1 based on the candidate probabilities respectively corresponding to the K candidate object types, to obtain a target probability 1 that the object type of the sample object is the candidate object type 1. Normalization processing is performed on the candidate probability 2 based on the candidate probabilities respectively corresponding to the K candidate object types, to obtain a target probability 2 that the object type of the sample object is the candidate object type 2. A similar operation is performed until target probabilities respectively corresponding to the K candidate object types are obtained. The computer device determines the predicted object type of the sample object based on the target probabilities that the object type of the sample object are respectively the candidate object types.

The candidate object type is corrected to obtain the predicted object type of the sample object, so that accuracy of the object type predicted by the multimedia recognition model can be improved, and a difference degree between predicted object types of different sample objects can be improved. In an example, K is 3, and the initial probabilities corresponding to three candidate object types are 0.88, 0.05, and 0.07 respectively. The object-type prediction deviation reflects that the initial probabilities that are of the K candidate object types and that are outputted by the initial multimedia recognition model each are usually greater than a real probability by a preset probability difference, for example, 0.2. In the manner 2, after the initial probabilities corresponding to the three candidate object types are corrected, obtained target probabilities corresponding to the three candidate object types are respectively 0.967, 0.0152, and 0.0178. It can be learned that the target probability that the object type of the sample object in the sample multimedia data is the candidate object type 1 is much greater than the target probability that the object type of the sample object in the sample multimedia data is the candidate object type 2 and the target probability that the object type of the sample object in the sample multimedia data is the candidate object type 3. A difference degree between target probabilities corresponding to different candidate object types is improved, so that accuracy of the object type predicted by the multimedia recognition model can be improved. Further, a difference degree between predicted object types of different sample objects is improved.

If the second distribution feature indicates that the candidate object attribute has a continuous distribution feature, the computer device may use, as the attribute deviation distribution function of the initial multimedia recognition model, Gaussian distribution in which a compliance variance is used as an attribute prediction deviation and a mean value is used as a candidate object attribute, and adjust the candidate object attribute based on the Gaussian distribution, to obtain the predicted object attribute of the sample object. A prediction result of the candidate object attribute may be floating-point values, for example, [0.1, 0.1, 0.2, 0.2, 0.3, 0.3, 0.4, 0.4]. For example, in an object detection task, such a group of floating-point values may represent coordinates (an object attribute) of four vertexes of a predicted bounding box of the object, and a value range of the object attribute is continuous values between 0 and N, where N may represent a maximum size of a picture for object detection. An example in which the coordinates of the four vertexes of the bounding box of the object in the picture are used as the object attribute is used for description herein. Other information about a location of the object in the picture may alternatively be used as the object attribute.

The computer device may perform exponentiation on the candidate object attribute based on the object-attribute prediction deviation, to obtain an initial object attribute, and then perform multiplication processing on the initial object attribute based on the object-attribute prediction deviation, to obtain the predicted object attribute of the sample object.

S105: Adjust the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute that are of an object in target multimedia data.

In this embodiment of this application, the computer device may determine a total prediction error of the initial multimedia recognition model based on the predicted object type, the predicted object attribute, the labeled object type, and the labeled object attribute. The total prediction error herein is configured for reflecting accuracy of the object type and the object attribute that are of the object in the sample multimedia data and that are predicted by the initial multimedia recognition model. When the total prediction error is larger, the accuracy of the object type and the object attribute that are of the object in the sample multimedia data and that are predicted by the initial multimedia recognition model is lower. Conversely, when the total prediction error is smaller, the accuracy of the object type and the object attribute that are of the object in the sample multimedia data and that are predicted by the initial multimedia recognition model is higher. Further, the computer device may adjust the initial multimedia recognition model based on the total prediction error, to obtain the target multimedia recognition model configured for recognizing the object type and the object attribute that are of the object in the target multimedia data.

The computer device may adjust the initial multimedia recognition model in either of the following two manners, to obtain the target multimedia recognition model.

Manner 1: The computer device may select, based on a distribution feature of the predicted object type, a first predicted probability distribution function corresponding to the predicted object type. The first predicted probability distribution function is configured for reflecting probability distribution corresponding to the predicted object type. For example, the distribution feature of the predicted object type is a discrete distribution feature. The distribution feature of the predicted object type is the same as a distribution feature of the candidate object type. Further, the computer device may select, based on a distribution feature of the predicted object attribute, a second predicted probability distribution function corresponding to the predicted object attribute. The second predicted probability distribution function is configured for reflecting probability distribution of the predicted object attribute. For example, the distribution feature of the predicted object attribute is a continuous distribution feature. The distribution feature of the predicted object attribute is the same as a distribution feature of the candidate object attribute. Further, the computer device may determine a first total prediction error of the initial multimedia recognition model based on the first predicted probability distribution function, the second predicted probability distribution function, the predicted object type, the predicted object attribute, the labeled object type, and the labeled object attribute. The computer device adjusts the initial multimedia recognition model based on the first total prediction error, to obtain the target multimedia recognition model. In this manner, when the initial multimedia recognition model is trained to fit the labeled object type and the labeled object attribute that are of the sample object, the prediction errors of the initial multimedia recognition model for the two types of tasks can be reduced, to improve media recognition accuracy and a generalization capability of the multimedia recognition model.

For example, when the distribution feature of the predicted object type is a discrete distribution feature, the first predicted probability distribution function corresponding to the predicted object type may be shown in the following formula (1):

$$p ( {y}_{1} \vert f ( x ) , {σ}_{1} ) = \frac{{e}^{\frac{f ( {x}_{j} )}{{σ}_{1}^{2}}}}{{\sum }_{1}^{K} {e}^{\frac{f ( {x}_{i} )}{{σ}_{1}^{2}}}} \qquad ( 1 )$$

In the formula (1), p(y₁|f(x), σ₁) represents the first predicted probability distribution function, x represents the sample multimedia data, y1 represents the labeled object type of the sample object in the sample multimedia data, K is a quantity of candidate object types, σ₁² represents the object-type prediction deviation, f(xⱼ) is an initial probability that the object type of the sample object belongs to a candidate object type j, and f(xᵢ) is an initial probability that the object type of the sample object belongs to a candidate object type i.

When the distribution feature of the predicted object attribute is a continuous distribution feature, the second predicted probability distribution function corresponding to the predicted object attribute may be shown in the following formula (2):

$$p ( {y}_{2} \vert f ( x ) , {σ}_{2} ) = \frac{1}{{σ}_{2} \sqrt{2 π}} {e}^{- \frac{{( {y}_{2} - f ( x ) )}^{2}}{2 {σ}_{2}^{2}}} \qquad ( 2 )$$

In the formula (2), p(y₂|f(x), σ₂) represents the second predicted probability distribution function, y2 represents the labeled object attribute of the sample object in the sample multimedia data, f(x) may be a candidate object attribute of a sample object in sample multimedia data x, and σ₂² is the object-attribute prediction deviation. Prediction on the object attribute may be used as a regression branch of the multimedia recognition model.

The determining the first total prediction error of the initial multimedia recognition model based on the first predicted probability distribution function, the second predicted probability distribution function, the predicted object type, the predicted object attribute, the labeled object type, and the labeled object attribute includes: The computer device may determine a total predicted probability distribution function of the initial multimedia recognition model based on the first predicted probability distribution function and the second predicted probability distribution function The total predicted probability distribution function is configured for reflecting probability distribution of the predicted object type and the predicted object attribute that are simultaneously outputted by the initial multimedia recognition model. Further, the computer device may perform maximum likelihood solving on the total predicted probability distribution function, to construct a maximum likelihood function of the initial multimedia recognition model. Then, the computer device obtains, through calculation, the first total prediction error of the initial multimedia recognition model based on the maximum likelihood function, the predicted object type, the predicted object attribute, the labeled object type, and the labeled object attribute.

For example, the total predicted probability distribution function of the initial multimedia recognition model may be represented by using the following formula (3):

$$p ( {y}_{1} , {y}_{2} \vert f ( x ) ) = p ( {y}_{1} \vert f ( x ) , {σ}_{1} ) \cdot p ( {y}_{2} \vert f ( x ) , {σ}_{2} ) \qquad ( 3 )$$

In the formula (3), p(y₁, y₂|f(x)) represents the total predicted probability distribution function of the initial multimedia recognition model, and is configured for reflecting probabilities that the predicted object type and the predicted object attribute that are simultaneously outputted by the initial multimedia recognition model are respectively equal to y1 and y2 when sample multimedia data x is inputted. Maximum likelihood solving is performed on the formula (3), to obtain the maximum likelihood function of the initial multimedia recognition model. Alternatively, the maximum likelihood function of the initial multimedia recognition model is constructed based on the formula (3), and maximum likelihood estimation of the total predicted probability distribution function is performed (maximum likelihood solving is performed), to estimate a parameter thereof. Solving the maximum likelihood estimation of the total predicted probability distribution function (performing the maximum likelihood solving) may be equivalent to minimizing a negative log-likelihood function of the total predicted probability distribution function. The negative log-likelihood function may be represented by using the following formula (4):

$$- log p ( {y}_{1} , {y}_{2} \vert f ( x ) ) = - log [ p ( {y}_{1} f ( x ) , {σ}_{1} ) \cdot p ( {y}_{2} \vert f ( x ) , {σ}_{2} ) ] = - log p ( {y}_{1} \vert f ( x ) , {σ}_{1} ) - log p ( {y}_{2} \vert f ( x ) , {σ}_{2} ) \qquad ( 4 )$$

In the formula (4), −log p(y₁,y₂|f(x)) represents the negative log-likelihood function, −log p(y₁|f(x), σ₁) represents a negative log-likelihood function corresponding to the first predicted probability distribution function, and −log p(y₂|f(x), σ₂) represents a negative log-likelihood function corresponding to the second predicted probability distribution function. A maximum likelihood function or the negative log-likelihood function corresponding to the first predicted probability distribution function is configured for reflecting an error of the object type predicted by the initial multimedia recognition model, and the negative log-likelihood function corresponding to the first predicted probability distribution function may be represented by using the following formula (5):

$$- log p ( {y}_{1} \vert f ( x ) , {σ}_{1} ) = - log \frac{{e}^{\frac{f ( {x}_{j} )}{{σ}^{2}}}}{{\sum }_{1}^{K} {e}^{\frac{f ( {x}_{i} )}{{σ}^{2}}}} = - \frac{1}{{σ}_{1}^{2}} f ( {x}_{j} ) + log {\sum }_{1}^{K} {e}^{\frac{f ( {x}_{i} )}{{σ}_{1}^{2}}} \qquad ( 5 )$$

A maximum likelihood function or the negative log-likelihood function corresponding to the second predicted probability distribution function is configured for reflecting an error of the object attribute predicted by the initial multimedia recognition model, and the negative log-likelihood function corresponding to the second predicted probability distribution function may be represented by using the following formula (6):

$$- log p ( {y}_{2} \vert f ( x ) , {σ}_{2} ) = - log \frac{1}{{σ}_{2} \sqrt{2 π}} {e}^{- \frac{{( {y}_{2} - f ( x ) )}^{2}}{2 {σ}_{2}^{2}}} = - log {e}^{- \frac{{( y - f ( x ) )}^{2}}{2 {σ}^{2}}} + log σ \sqrt{2 π} = \frac{1}{2 {σ}_{2}^{2}} {‖ {y}_{2} - f ( x ) ‖}^{2} + log {σ}_{2} + log \sqrt{2 π} \qquad ( 6 )$$

The obtaining, through calculation, the first total prediction error of the initial multimedia recognition model based on the maximum likelihood function, the predicted object type, the predicted object attribute, the labeled object type, and the labeled object attribute includes: The computer device may determine a cross-entropy function for describing a difference between the labeled object attribute and the predicted object attribute, and a mean-square error function for describing a difference between the predicted object type and the labeled object type. Further, the computer device adjusts the maximum likelihood function of the initial multimedia recognition model based on the cross-entropy function and the mean-square error function, to determine a total loss function of the initial multimedia recognition model. For example, the computer device adjusts the negative log-likelihood function of the initial multimedia recognition model based on the cross-entropy function and the mean-square error function. Then, the computer device substitutes the predicted object type, the predicted object attribute, the labeled object type, and the labeled object attribute into the total loss function, to obtain, through calculation, the first total prediction error of the initial multimedia recognition model.

The formula (5) and the formula (6) are substituted into the formula (4), and the negative log-likelihood function of the initial multimedia recognition model may alternatively be represented by using the following formula (7):

$$- log p ( {y}_{1} , {y}_{2} \vert f ( x ) ) = - \frac{1}{{σ}_{1}^{2}} f ( x ) + log \sum {e}^{\frac{f ( {x}_{i} )}{{σ}_{1}^{2}}} + \frac{1}{2 {σ}_{2}^{2}} {‖ {y}_{2} - f ( x ) ‖}^{2} + log {σ}_{2} + log \sqrt{2 π} \qquad ( 7 )$$

The mean-square error function may be MSE=∥y₂−f(x)∥², representing a mean-square error corresponding to the predicted object attribute. The cross-entropy function is

$$CE = - log p ( y \vert f ( x ) ) = - log \frac{{e}^{f ( x )}}{{\sum }_{1}^{K} {e}^{f ( x )}} = - f ( x ) + log {\sum }_{1}^{K} {e}^{f ( x )} ,$$

representing a cross entropy corresponding to the predicted object type. The mean-square error function and the cross-entropy function are substituted into the formula (6), and the negative log-likelihood function of the initial multimedia recognition model may alternatively be represented by using the following formula (8):

$$- log p ( {y}_{1} , {y}_{2} \vert f ( x ) ) = \frac{1}{2 {σ}_{2}^{2}} MSE + \frac{1}{{σ}_{1}^{2}} CE - \frac{1}{{σ}_{1}^{2}} CE - \frac{1}{{σ}_{1}^{2}} f ( x ) + log {\sum }_{1}^{K} {e}^{\frac{f ( {x}_{i} )}{{σ}_{1}^{2}}} = log {σ}_{2} + log \sqrt{2 π} = \frac{1}{2 {σ}_{2}^{2}} MSE + \frac{1}{{σ}_{1}^{2}} CE - \frac{1}{{σ}_{1}^{2}} ( - f ( x ) + log {\sum }_{1}^{K} {e}^{f ( x )} ) - \frac{1}{{σ}_{1}^{2}} f ( x ) + log {\sum }_{1}^{K} {e}^{\frac{f ( {x}_{i} )}{{σ}_{1}^{2}}} + log {σ}_{2} + log \sqrt{2 π} = \frac{1}{2 {σ}_{2}^{2}} MSE + \frac{1}{σ12} CE + \frac{1}{{σ}_{1}^{2}} f ( x ) - {log ( {\sum }_{1}^{K} {e}^{f ( x )} )}^{\frac{1}{{σ}_{1}^{2}}} - \frac{1}{{σ}_{1}^{2}} f ( x ) + log {\sum }_{1}^{K} {e}^{\frac{f ( {x}_{i} )}{{σ}_{1}^{2}}} + log {σ}_{2} + log \sqrt{2 π} = \frac{1}{2 {σ}_{2}^{2}} MSE + \frac{1}{σ12} CE + log \frac{{σ}_{1} \cdot \frac{1}{{σ}_{1}} \cdot {\sum }_{1}^{K} {e}^{\frac{f ( {x}_{i} )}{{σ}_{1}^{2}}}}{{( {\sum }_{1}^{K} {e}^{f ( x )} )}^{\frac{1}{{σ}_{1}^{2}}}} + log {σ}_{2} + log \sqrt{2 π} = \frac{1}{2 {σ}_{2}^{2}} MSE + \frac{1}{σ12} CE + log \frac{\frac{1}{{σ}_{1}} \cdot Σ {e}^{\frac{f ( {x}_{i} )}{{σ}_{1}^{2}}}}{{( Σ {e}^{f ( x )} )}^{\frac{1}{{σ}_{1}^{2}}}} + log {σ}_{1} + log {σ}_{2} + log \sqrt{2 π} \qquad ( 8 )$$

Due to

$${lim}_{{σ}_{1} \to 1} \frac{1}{{σ}_{1}} \cdot {\sum }_{1}^{K} {e}^{\frac{f ( {x}_{i} )}{{σ}_{1}^{2}}} = {( {\sum }_{1}^{K} {e}^{f ( x )} )}^{\frac{1}{{σ}_{1}^{2}}}$$

in the formula (8), a constant term in the formula (8) is ignored, and the formula (8) may be approximately equal to a formula (9).

$$- log p ( {y}_{1} , {y}_{2} \vert f ( x ) ) \approx \frac{1}{2 {σ}_{2}^{2}} MSE + \frac{1}{{σ}_{1}^{2}} CE + log {σ}_{1} \cdot {σ}_{2} \qquad ( 9 )$$

Further, a negative log-likelihood function in the formula (9) may be determined as the total loss function of the initial multimedia recognition model. In other words, the total loss function of the initial multimedia recognition model may be represented by using the following formula (10):

$$min {ℒ}_{MTL} = min \frac{1}{2 {σ}_{2}^{2}} MSE + \frac{1}{{σ}_{1}^{2}} CE + log {σ}_{1} \cdot {σ}_{2} \qquad ( 10 )$$

[symbol] _{MTL} in the formula (10) represents the total loss function of the initial multimedia recognition model, and min [symbol] _{MTL} represents minimizing the total loss function of the initial multimedia recognition model.

It can be learned based on the formula (10) that the total loss function of the initial multimedia recognition model is related to the object-attribute prediction deviation and the object-type prediction deviation. If the object-attribute prediction deviation and the object-type prediction deviation are larger, although a value of

$$\frac{1}{2 {σ}_{2}^{2}} MSE + \frac{1}{{σ}_{1}^{2}} CE$$

may be small, a value of log σ₁·σ₂ is increased. Conversely, if the object-attribute prediction deviation and the object-type prediction deviation are smaller, although the value of log σ₁·σ₂ is small, the value of

$$\frac{1}{2 {σ}_{2}^{2}} MSE + \frac{1}{{σ}_{1}^{2}} CE$$

is large. Therefore, in this embodiment of this application, the object-attribute prediction deviation and the object-type prediction deviation are introduced, so that importance degrees of different recognition tasks can be dynamically adjusted. Therefore, prediction errors of the different recognition tasks are dynamically balanced, to avoid a seesaw phenomenon (to be specific, an improvement of a recognition effect of one recognition task leads to a decrease in a recognition result of another recognition task) easily occurring in the multimedia recognition model, and improve media recognition accuracy of the multimedia recognition model. In particular, the object-attribute prediction deviation and the object-type prediction deviation also belong to a model parameter of the initial multimedia recognition model. Therefore, in a process of adjusting the initial multimedia recognition model, the object-attribute prediction deviation and the object-type prediction deviation may also be adjusted, so that the prediction errors of the initial multimedia recognition model for the two types of tasks are dynamically balanced, to avoid the seesaw phenomenon occurring in the initial multimedia recognition model, and improve the media recognition accuracy and a generalization capability of the multimedia recognition model.

For consideration of engineering implementation and numerical stability, s₁: log σ₁² and s₂: log σ₂² are set. In this case, σ₁²=e^{s1} and σ₂²=e^{s2}. The foregoing content is substituted into the formula (10), and the formula (10) may be simplified into the following formula (11):

$$min {ℒ}_{MTL} = min \frac{1}{2} {e}^{- {s}_{2}} MSE + {e}^{- {s}_{1}} CE + \frac{1}{2} {s}_{1} + \frac{1}{2} {s}_{2} \qquad ( 11 )$$

The adjusting the initial multimedia recognition model based on the first total prediction error, to obtain the target multimedia recognition model includes: The computer device may perform verification on a state of the initial multimedia recognition model based on the first total prediction error; and if the state of the initial multimedia recognition model is a converged state, determine the initial multimedia recognition model as the target multimedia recognition model. If the state of the initial multimedia recognition model is a non-converged state, the initial multimedia recognition model is adjusted based on the first total prediction error. When a state of an adjusted initial multimedia recognition model is the converged state, the adjusted initial multimedia recognition model in the converged state is determined as the target multimedia recognition model. The initial multimedia recognition model is adjusted based on the first total prediction error, so that when the initial multimedia recognition model is trained to fit the labeled brand type and the labeled brand location, the prediction errors of the initial multimedia recognition model for the two types of tasks are reduced. Therefore, the prediction errors of the two types of tasks are dynamically balanced, to avoid the seesaw phenomenon, and improve the media recognition accuracy and the generalization capability of the multimedia recognition model.

The adjusting the initial multimedia recognition model based on the first total prediction error, to obtain the target multimedia recognition model includes: The computer device may perform verification on a state of the initial multimedia recognition model based on the first total prediction error. If the state of the initial multimedia recognition model is a converged state, the initial multimedia recognition model may be determined as the target multimedia recognition model. If the state of the initial multimedia recognition model is a non-converged state, the initial multimedia recognition model is adjusted based on the first total prediction error, and a quantity of times for which the initial multimedia recognition model is adjusted is obtained. If the quantity of times is greater than a times threshold, an adjusted initial multimedia recognition model is determined as the target multimedia recognition model. One time of adjustment on the initial multimedia recognition model may be adjustment performed on the initial multimedia recognition model based on first total prediction errors (for example, a cumulative sum of all the first total prediction errors) corresponding to all sample multimedia data in a training set. Alternatively, one time of adjustment on the initial multimedia recognition model may be adjustment performed on the initial multimedia recognition model based on a first total prediction error corresponding to one piece of sample multimedia data in a training set.

That the initial multimedia recognition model is in the converged state may be that the first total prediction error is less than or equal to an error threshold. That the initial multimedia recognition model is in the non-converged state may be that the first total prediction error is greater than the error threshold. The error threshold is obtained through calculation based on the total loss function. For example, the error threshold may be a minimum value of the total loss function.

Manner 2: The computer device may determine an object-type prediction error of the initial multimedia recognition model based on the predicted object type and the labeled object type, for example, may determine a cross entropy between the predicted object type and the labeled object type as the object-type prediction error of the initial multimedia recognition model. Further, the computer device may determine an object-attribute prediction error of the initial multimedia recognition model based on the predicted object attribute and the labeled object attribute, for example, determine a mean square error between the predicted object attribute and the labeled object attribute as the object-attribute prediction error of the initial multimedia recognition model. Further, the computer device may adjust the initial multimedia recognition model based on the object-type prediction error and the object-attribute prediction error respectively. When the two types of prediction errors of an adjusted initial multimedia recognition model are both less than a prediction error value, the adjusted initial multimedia recognition model is determined as the target multimedia recognition model. Alternatively, the computer device may adjust the initial multimedia recognition model based on the two types of prediction errors together. When the two types of prediction errors of an adjusted initial multimedia recognition model are dynamically balanced, the adjusted initial multimedia recognition model is determined as the target multimedia recognition model. The dynamic balance herein may be that a sum of the two types of prediction errors is less than an error threshold. The initial multimedia recognition model is adjusted based on a second total prediction error, so that when the initial multimedia recognition model is trained to fit the labeled brand type and the labeled brand location, the prediction errors of the initial multimedia recognition model for the two types of tasks are reduced. Therefore, the prediction errors of the two types of tasks are dynamically balanced, to avoid the seesaw phenomenon, and improve the media recognition accuracy and the generalization capability of the multimedia recognition model.

The computer device may generate the second total prediction error of the initial multimedia recognition model based on the object-type prediction error and the object-attribute prediction error. For example, the computer device may determine a sum of the object-type prediction error and the object-attribute prediction error as the second total prediction error of the initial multimedia recognition model. Alternatively, the computer device may perform weighted summation on the object-type prediction error and the object-attribute prediction error, to obtain the second total prediction error of the initial multimedia recognition model. Weights respectively corresponding to the object-type prediction error and the object-attribute prediction error may be determined based on an application scenario. For example, in a scenario in which a brand type is focused, a larger weight may be set for the object-type prediction error, and a smaller weight may be set for the object-attribute prediction error. Further, the computer device may adjust the initial multimedia recognition model based on the second total prediction error, to obtain the target multimedia recognition model. The target multimedia recognition model is obtained by adjusting the initial multimedia recognition model based on the object-type prediction error and the object-attribute prediction error, to help the initial multimedia recognition model fit an object attribute label (that is, the labeled object attribute) and an object type label (that is, the labeled object type) of the sample object, and improve the media recognition accuracy of the multimedia recognition model.

The initial multimedia recognition model in the embodiments of this application may be a faster region-based convolutional neural network (R-CNN), a backbone network selection residual neural network (ResNet) 101, or another similar network structure, for example, a ResNet 50, a data-efficient image transformer (DEIT), or an ResNeXt. During training of the initial multimedia recognition model, the model parameter of the initial multimedia recognition model may be updated in a manner in which an adaptive moment estimation (Adam) optimization algorithm is used to perform reverse propagation and gradient update, or the algorithm may be updated by using another gradient, such as a stochastic gradient descent (SGD), an adaptive moment estimation weight decay (AdamW), or an adaptive gradient algorithm (Adagrad).

The computer device may perform verification on a state of the initial multimedia recognition model based on the second total prediction error, to obtain a verification result. The verification result indicates that the initial multimedia recognition model is in a converged state, or the verification result indicates that the initial multimedia recognition model is in a non-converged state. If the verification result indicates that the initial multimedia recognition model is in the converged state, the initial multimedia recognition model may be determined as the target multimedia recognition model. If the verification result indicates that the initial multimedia recognition model is in the non-converged state, the initial multimedia recognition model is adjusted based on the total prediction error until an adjusted initial multimedia recognition model is in the converged state. The adjusted initial multimedia recognition model in the converged state is determined as the target multimedia recognition model, so that the media recognition accuracy of the multimedia recognition model can be improved. In addition, during training, a loss function and a prediction branch in the initial/target multimedia recognition model require a small model computing amount and small time consumption, so that a computing resource for model training can be saved.

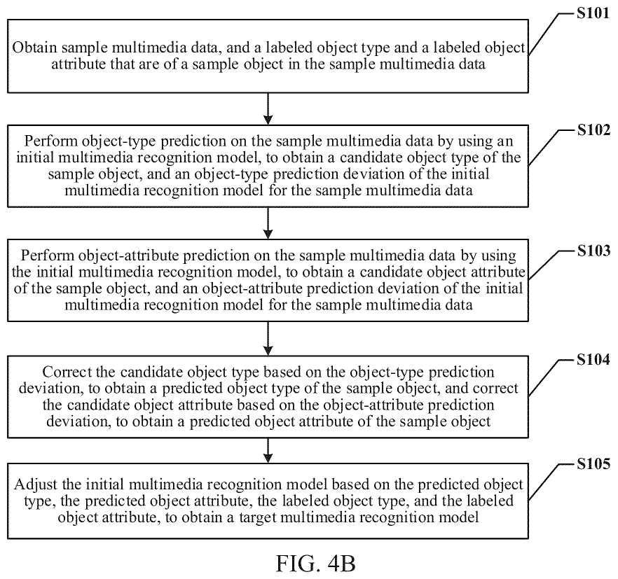

Further, FIG. 5 is a schematic flowchart of a multimedia data processing method according to an embodiment of this application. As shown in FIG. 5, the method may be performed by any terminal in the terminal cluster in FIG. 1, or may be performed by the server in FIG. 1. In this embodiment of this application, a device configured to perform the multimedia data processing method may be collectively referred to as a computer device. The method may include the following operations.

S201: Obtain sample multimedia data, and a labeled object type and a labeled object attribute that are of a sample object in the sample multimedia data.

S202: Perform object-type prediction on the sample multimedia data by using an initial multimedia recognition model, to obtain a candidate object type of the sample object, and an object-type prediction deviation of the initial multimedia recognition model for the sample multimedia data.

S203: Perform object-attribute prediction on the sample multimedia data by using the initial multimedia recognition model, to obtain a candidate object attribute of the sample object, and an object-attribute prediction deviation of the initial multimedia recognition model for the sample multimedia data.

S204: Correct the candidate object type based on the object-type prediction deviation, to obtain a predicted object type of the sample object, and correct the candidate object attribute based on the object-attribute prediction deviation, to obtain a predicted object attribute of the sample object.

S205: Adjust the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute that are of an object in target multimedia data.

In this embodiment of this application, for an explanation of operation S201, refer to the explanation of operation S101 in FIG. 4B. For an explanation of operation S202, refer to the explanation of operation S102 in FIG. 4B. For an explanation of operation S203, refer to the explanation of operation S103 in FIG. 4B. For an explanation of operation S204, refer to the explanation of operation S104 in FIG. 4B. For an explanation of operation S205, refer to the explanation of operation S105 in FIG. 4B. Repeated content is not described herein again.

S206: Perform object-type recognition on the target multimedia data by using the target multimedia recognition model, to obtain an initial object type of the object in the target multimedia data, and an object-type recognition deviation of the target multimedia recognition model for the target multimedia data.

In this embodiment of this application, when the object type and the object attribute in the target multimedia data needs to be recognized, the computer device may input the target multimedia data into the target multimedia recognition model, and perform object-type recognition on the target multimedia data by using the target multimedia recognition model, to obtain the initial object type of the object in the target multimedia data, and the object-type recognition deviation of the target multimedia recognition model for the target multimedia data. The object-type recognition deviation herein may be outputted by the initial multimedia recognition model. The object-type recognition deviation is obtained by the initial multimedia recognition model through learning based on historical sample multimedia data and the current sample multimedia data. The object-type recognition deviation belongs to a statistical parameter of the initial multimedia recognition model. The object-type recognition deviation herein is configured for reflecting uncertainty of object-type recognition performed by the target multimedia recognition model on the target multimedia data. In other words, the object-type recognition deviation is configured for reflecting a deviation between the labeled object type and the initial object type outputted by the target multimedia recognition model.

S207: Perform object-attribute recognition on the target multimedia data by using the target multimedia recognition model, to obtain an initial object attribute of the object in the target multimedia data, and an object-attribute recognition deviation of the target multimedia recognition model for the target multimedia data.

In this embodiment of this application, the computer device may perform object-attribute recognition on the target multimedia data by using the target multimedia recognition model, to obtain the initial object attribute of the object in the target multimedia data, and the object-attribute recognition deviation of the target multimedia recognition model for the target multimedia data. The object-attribute recognition deviation is configured for reflecting uncertainty of object-attribute recognition performed by the target multimedia recognition model on the target multimedia data. In other words, the object-attribute recognition deviation is configured for reflecting a deviation between the labeled object attribute and an initial object attribute outputted by the target multimedia recognition model.

S208: Correct the initial object type based on the object-type recognition deviation, to obtain a target object type of the object in the target multimedia data.

In this embodiment of this application, the computer device may correct the initial object type based on the object-type recognition deviation, to obtain the target object type of the object in the target multimedia data. For an implementation of correcting the initial object type, refer to the foregoing implementation of correcting the candidate object type in FIG. 4B. Repeated content is not described herein again.

S209: Correct the initial object attribute based on the object-attribute recognition deviation, to obtain a target object attribute of the object in the target multimedia data.

In this embodiment of this application, the computer device may correct the initial object attribute based on the object-attribute recognition deviation, to obtain the target object attribute of the object in the target multimedia data. For an implementation of correcting the initial object attribute, refer to the foregoing implementation of correcting the candidate object attribute in FIG. 4B. Repeated content is not described herein again.

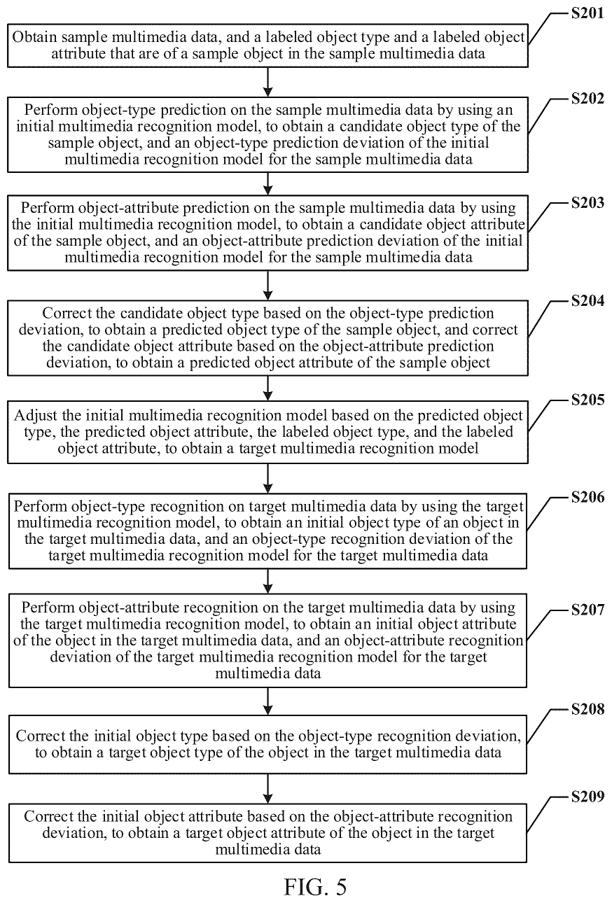

For example, as shown in FIG. 6, after the computer device obtains the target multimedia recognition model, it is assumed that the target multimedia recognition model has a function of recognizing a brand type and a brand location that correspond to a brand in multimedia data (for example, image data). The target multimedia recognition model may be configured for recognizing a brand type and a brand location that correspond to a brand in any multimedia data. The brand may be presented in a form of a logo, a text, or the like in the multimedia data. As shown in FIG. 6, it is assumed that a brand type and a brand location that are of clothes worn by a person in the target multimedia data in FIG. 6 need to be recognized. The computer device may input the target multimedia data into the target multimedia recognition model, and perform brand-type recognition on the target multimedia data by using the target multimedia recognition model, to obtain initial probabilities respectively corresponding to initial brand types included in the target multimedia data (to be specific, respective corresponding initial probabilities that brand types corresponding to brands in the target multimedia data are K candidate brand types), and a brand-type recognition deviation of the target multimedia recognition model for the target multimedia data. Brand-location recognition is performed on the target multimedia data by using the target multimedia recognition model, to obtain initial brand locations (for example, coordinates) corresponding to the brands in the target multimedia data, and a brand-location recognition deviation of the target multimedia recognition model for the target multimedia data. Further, the computer device may correct, based on the brand-type recognition deviation, the initial probabilities respectively corresponding to the K candidate brand types, to obtain target probabilities respectively corresponding to the K candidate brand types. A candidate brand with a largest target probability in the K candidate brand types is used as a brand type (for example, a brand A) corresponding to the brand in the target multimedia data. The initial brand locations are adjusted based on the brand-location recognition deviation, to obtain a brand location corresponding to the brand in the target multimedia data. As shown in FIG. 6, the target multimedia recognition model may mark a brand location in the target multimedia data by using a rectangular box, and mark, in the rectangular box, a brand type and a target probability (that is, confidence) corresponding to the brand type. In practice, it is found that the target multimedia recognition model in this solution can more comprehensively recognize the brand type in the multimedia data, and can more accurately recognize the brand location. After obtaining the brand type and the brand location in the target multimedia data, the computer device may set a label for the target multimedia data based on the brand type and the brand location. The target multimedia data with the label may be used in an application scenario such as image retrieval, image classification, or multimedia data recommendation.

In this embodiment of this application, after training the initial multimedia recognition model to obtain the target multimedia recognition model, the computer device may perform object-type recognition on the target multimedia data by using the target multimedia recognition model, to obtain the initial object type of the object in the target multimedia data, and the object-type recognition deviation of the target multimedia recognition model for the target multimedia data, and perform object-attribute recognition on the target multimedia data by using the target multimedia recognition model, to obtain the initial object attribute of the object in the target multimedia data, and the object-attribute recognition deviation of the target multimedia recognition model for the target multimedia data. Further, the initial object type is corrected based on the object-type recognition deviation, to obtain the target object type of the object in the target multimedia data, and the initial object attribute is corrected based on the object-attribute recognition deviation, to obtain the target object attribute of the object in the target multimedia data, so that accuracy of the target object attribute and the target object type in the target multimedia data is improved.

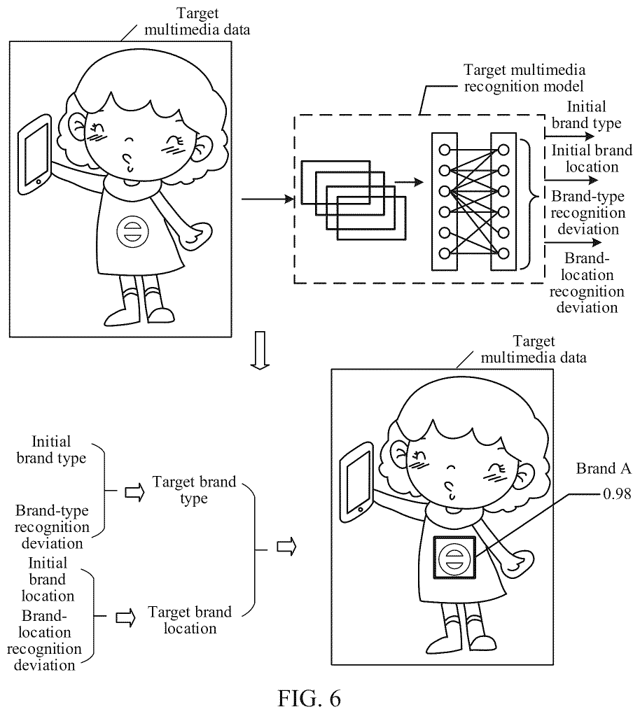

FIG. 7 is a schematic diagram of a structure of a multimedia data processing apparatus according to an embodiment of this application. As shown in FIG. 7, the multimedia data processing apparatus may include an obtaining module 711, a prediction module 712, a correction module 713, an adjustment module 714, and a recognition module 715.

The obtaining module 711 is configured to obtain sample multimedia data, and a labeled object type and a labeled object attribute that are of a sample object in the sample multimedia data.

The prediction module 712 is configured to perform object-type prediction on the sample multimedia data by using an initial multimedia recognition model, to obtain a candidate object type of the sample object; and perform object-attribute prediction on the sample multimedia data by using the initial multimedia recognition model, to obtain a candidate object attribute of the sample object.

The correction module 713 is configured to determine a predicted object type of the sample object from the candidate object type, and determine a predicted object attribute of the sample object from the candidate object attribute.

The adjustment module 714 is configured to adjust the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute that are of an object in target multimedia data.

The prediction module 712 is further configured to determine an object-type prediction deviation of the initial multimedia recognition model for the sample multimedia data and an object-attribute prediction deviation of the initial multimedia recognition model for the sample multimedia data.

The correction module 713 is further configured to: when determining the predicted object type of the sample object from the candidate object type, and determining the predicted object attribute of the sample object from the candidate object attribute, correct the candidate object type based on the object-type prediction deviation, to obtain the predicted object type of the sample object, and correct the candidate object attribute based on the object-attribute prediction deviation, to obtain the predicted object attribute of the sample object.

The correction module 713 includes a first determining unit 71a and a correction unit 72a.

The first determining unit 71a is configured to determine a first distribution feature of the candidate object type and a second distribution feature of the candidate object attribute.

The correction unit 72a is configured to correct the candidate object type based on the first distribution feature and the object-type prediction deviation, to obtain the predicted object type of the sample object; and correct the candidate object attribute based on the second distribution feature and the object-attribute prediction deviation, to obtain the predicted object attribute of the sample object.

That the correction unit 72a corrects the candidate object type based on the first distribution feature and the object-type prediction deviation, to obtain the predicted object type of the sample object includes:
if the first distribution feature indicates that the candidate object type has a discrete distribution feature, obtaining a ratio of an initial probability that an object type of the sample object is the candidate object type to the object-type prediction deviation;
performing exponentiation on the ratio, to obtain a candidate probability that the object type of the sample object is the candidate object type;
performing normalization processing on the candidate probability that the object type of the sample object is the candidate object type, to obtain a target probability that the object type of the sample object is the candidate object type; and
determining the predicted object type of the sample object based on the target probability that the object type of the sample object is the candidate object type.

That the correction unit 72a corrects the candidate object attribute based on the second distribution feature and the object-attribute prediction deviation, to obtain the predicted object attribute of the sample object includes:
if the second distribution feature indicates that the candidate object attribute has a continuous distribution feature, performing exponentiation on the candidate object attribute based on the object-attribute prediction deviation, to obtain an initial object attribute; and
performing multiplication processing on the initial object attribute based on the object-attribute prediction deviation, to obtain the predicted object attribute of the sample object.

The adjustment module 714 includes a selection unit 73a, a second determining unit 74a, and an adjustment unit 75a.

The selection unit 73a is configured to select, based on a distribution feature of the predicted object type, a first predicted probability distribution function corresponding to the predicted object type; and select, based on a distribution feature of the predicted object attribute, a second predicted probability distribution function corresponding to the predicted object attribute.

The second determining unit 73a is configured to determine a first total prediction error of the initial multimedia recognition model based on the first predicted probability distribution function, the second predicted probability distribution function, the predicted object type, the predicted object attribute, the labeled object type, and the labeled object attribute.

The adjustment unit 75a is configured to adjust the initial multimedia recognition model based on the first total prediction error, to obtain the target multimedia recognition model.

That the second determining unit 74a determines the first total prediction error of the initial multimedia recognition model based on the first predicted probability distribution function, the second predicted probability distribution function, the predicted object type, the predicted object attribute, the labeled object type, and the labeled object attribute includes:
determining a total predicted probability distribution function of the initial multimedia recognition model based on the first predicted probability distribution function and the second predicted probability distribution function, where the total predicted probability distribution function is configured for reflecting probability distribution of the predicted object type and the predicted object attribute that are simultaneously outputted by the initial multimedia recognition model;
performing maximum likelihood solving on the total predicted probability distribution function, to construct a maximum likelihood function of the initial multimedia recognition model; and
obtaining, through calculation, the first total prediction error of the initial multimedia recognition model based on the maximum likelihood function, the predicted object type, the predicted object attribute, the labeled object type, and the labeled object attribute.

That the second determining unit 74a obtains, through calculation, the first total prediction error of the initial multimedia recognition model based on the maximum likelihood function, the predicted object type, the predicted object attribute, the labeled object type, and the labeled object attribute includes:
obtaining a cross-entropy function for describing a difference between the predicted object type and the labeled object type, and a mean-square error function for describing a difference between the labeled object attribute and the predicted object attribute;
adjusting the maximum likelihood function of the initial multimedia recognition model based on the cross-entropy function and the mean-square error function, to determine a total loss function of the initial multimedia recognition model; and
substituting the predicted object type, the predicted object attribute, the labeled object type, and the labeled object attribute into the total loss function, to obtain, through calculation, the first total prediction error of the initial multimedia recognition model.

That the adjustment unit 75a adjusts the initial multimedia recognition model based on the first total prediction error, to obtain the target multimedia recognition model includes:
if the first total prediction error is greater than an error threshold, adjusting the initial multimedia recognition model based on the first total prediction error, where the error threshold is obtained through calculation based on the total loss function; and
when a first total prediction error of an adjusted initial multimedia recognition model is less than the error threshold, determining, as the target multimedia recognition model, the adjusted initial multimedia recognition model whose first total prediction error is less than the error threshold.

The second determining unit 74a is further configured to determine an object-type prediction error of the initial multimedia recognition model based on the predicted object type and the labeled object type; and determine an object-attribute prediction error of the initial multimedia recognition model based on the predicted object attribute and the labeled object attribute.

The adjustment unit 75a is further configured to adjust the initial multimedia recognition model based on the object-type prediction error and the object-attribute prediction error, to obtain the target multimedia recognition model.

That the adjustment unit 75a adjusts the initial multimedia recognition model based on the object-type prediction error and the object-attribute prediction error, to obtain the target multimedia recognition model includes:
generating a second total prediction error of the initial multimedia recognition model based on the object-type prediction error and the object-attribute prediction error; and
adjusting the initial multimedia recognition model based on the second total prediction error, to obtain the target multimedia recognition model.

That the adjustment unit 75a adjusts the initial multimedia recognition model based on the second total prediction error, to obtain the target multimedia recognition model includes:
performing verification on a state of the initial multimedia recognition model based on the second total prediction error, to obtain a verification result;
if the verification result indicates that the initial multimedia recognition model is in a non-converged state, adjusting the initial multimedia recognition model based on the total prediction error until an adjusted initial multimedia recognition model is in a converged state; and
determining the adjusted initial multimedia recognition model in the converged state as the target multimedia recognition model.

The apparatus further includes a recognition module 715, configured to perform object-type recognition on the target multimedia data by using the target multimedia recognition model, to obtain an initial object type of the object in the target multimedia data, and an object-type recognition deviation of the target multimedia recognition model for the target multimedia data; and perform object-attribute recognition on the target multimedia data by using the target multimedia recognition model, to obtain an initial object attribute of the object in the target multimedia data, and an object-attribute recognition deviation of the target multimedia recognition model for the target multimedia data.

The correction module 713 is further configured to correct the initial object type based on the object-type recognition deviation, to obtain the target object type of the object in the target multimedia data; and correct the initial object attribute based on the object-attribute recognition deviation, to obtain the target object attribute of the object in the target multimedia data.

In the embodiments of this application, in a process of training the initial multimedia recognition model, the object-type prediction deviation and the object-attribute prediction deviation that are of the initial multimedia recognition model are introduced, and the initial object type is corrected based on the object-type recognition deviation, to obtain the predicted object type of the sample object. In this way, accuracy of the object type predicted by the initial multimedia recognition model can be improved, to help improve a difference degree between object types of different sample objects. The initial object attribute is corrected based on the object-attribute prediction deviation, to obtain the predicted object attribute of the sample object. In this way, accuracy of the object attribute predicted by the initial multimedia recognition model can be improved, to help improve a difference degree between object attributes of different sample objects. Further, the initial multimedia recognition model is adjusted based on the predicted object type, the predicted object attribute, the labeled object type, and the labeled object attribute, to obtain the target multimedia recognition model configured for recognizing the target object type and the target object attribute that are of the object in the target multimedia data. In other words, when the initial multimedia recognition model is trained to fit the labeled object type and the labeled object attribute of the sample object, prediction errors of the initial multimedia recognition model for the two types of tasks are reduced, to improve media recognition accuracy and a generalization capability of the multimedia recognition model.

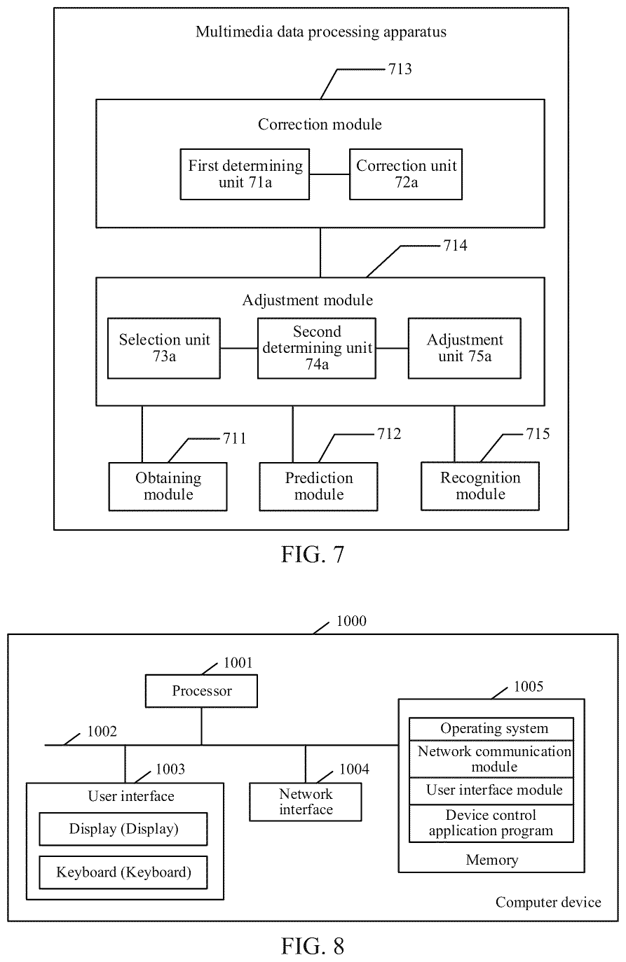

FIG. 8 is a schematic diagram of a structure of a computer device according to an embodiment of this application. As shown in FIG. 8, the computer device 1000 may be the apparatus in the foregoing method, and may specifically be the terminal or the server. The computer device 1000 includes a processor 1001, a network interface 1004, and a memory 1005. In addition, the computer device 1000 may further include: a user interface 1003, and at least one communication bus 1002. The communication bus 1002 is configured to implement connection communication between the components. In some embodiments, the user interface 1003 may include a display and a keyboard. In some embodiments, the user interface 1003 may further include a standard wired interface and a standard wireless interface. In some embodiments, the network interface 1004 may include a standard wired interface and a standard wireless interface (such as a wireless fidelity (Wi-Fi) interface). The memory 1005 may be a high-speed random access memory (RAM) memory, or may be a non-volatile memory, for example, at least one magnetic disk memory. In some embodiments, the memory 1005 may alternatively be at least one storage apparatus away from the foregoing processor 1001. As shown in FIG. 8, as a computer-readable storage medium, the memory 1005 may include an operating system, a network communication module, a user interface module, and a device control application program.

In the computer device 1000 shown in FIG. 8, the network interface 1004 may provide a network communication function. The user interface 1003 is configured to provide an input interface. The processor 1001 may be configured to invoke the device control application program stored in the memory 1005, to implement the following operations:
obtaining sample multimedia data, and a labeled object type and a labeled object attribute that are of a sample object in the sample multimedia data;
performing object-type prediction on the sample multimedia data by using an initial multimedia recognition model, to obtain a candidate object type of the sample object;
performing object-attribute prediction on the sample multimedia data by using the initial multimedia recognition model, to obtain a candidate object attribute of the sample object;
determining a predicted object type of the sample object from the candidate object type, and determining a predicted object attribute of the sample object from the candidate object attribute; and
adjusting the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute that are of an object in target multimedia data.

The processor 1001 may be configured to invoke the device control application program stored in the memory 1005, to determine an object-type prediction deviation of the initial multimedia recognition model for the sample multimedia data and an object-attribute prediction deviation of the initial multimedia recognition model for the sample multimedia data.

The determining a predicted object type of the sample object from the candidate object type, and determining a predicted object attribute of the sample object from the candidate object attribute includes: correcting the candidate object type based on the object-type prediction deviation, to obtain the predicted object type of the sample object, and correcting the candidate object attribute based on the object-attribute prediction deviation, to obtain the predicted object attribute of the sample object.

That the processor 1001 may be configured to invoke the device control application program stored in the memory 1005, to correct the candidate object type based on the object-type prediction deviation, to obtain the predicted object type of the sample object, and correct the candidate object attribute based on the object-attribute prediction deviation, to obtain the predicted object attribute of the sample object includes:
determining a first distribution feature of the candidate object type and a second distribution feature of the candidate object attribute;
correcting the candidate object type based on the first distribution feature and the object-type prediction deviation, to obtain the predicted object type of the sample object; and
correcting the candidate object attribute based on the second distribution feature and the object-attribute prediction deviation, to obtain the predicted object attribute of the sample object.

That the processor 1001 may be configured to invoke the device control application program stored in the memory 1005, to correct the candidate object type based on the first distribution feature and the object-type prediction deviation, to obtain the predicted object type of the sample object includes:
if the first distribution feature indicates that the candidate object type has a discrete distribution feature, obtaining a ratio of an initial probability that an object type of the sample object is the candidate object type to the object-type prediction deviation;
performing exponentiation on the ratio, to obtain a candidate probability that the object type of the sample object is the candidate object type;
performing normalization processing on the candidate probability that the object type of the sample object is the candidate object type, to obtain a target probability that the object type of the sample object is the candidate object type; and
determining the predicted object type of the sample object based on the target probability that the object type of the sample object is the candidate object type.

That the processor 1001 may be configured to invoke the device control application program stored in the memory 1005, to correct the candidate object attribute based on the second distribution feature and the object-attribute prediction deviation, to obtain the predicted object attribute of the sample object includes:
if the second distribution feature indicates that the candidate object attribute has a continuous distribution feature, performing exponentiation on the candidate object attribute based on the object-attribute prediction deviation, to obtain an initial object attribute; and
performing multiplication processing on the initial object attribute based on the object-attribute prediction deviation, to obtain the predicted object attribute of the sample object.

That the processor 1001 may be configured to invoke the device control application program stored in the memory 1005, to adjust the initial multimedia recognition model based on the predicted object type, the predicted object attribute, the labeled object type, and the labeled object attribute, to obtain the target multimedia recognition model includes:
selecting, based on a distribution feature of the predicted object type, a first predicted probability distribution function corresponding to the predicted object type;
selecting, based on a distribution feature of the predicted object attribute, a second predicted probability distribution function corresponding to the predicted object attribute;
determining a first total prediction error of the initial multimedia recognition model based on the first predicted probability distribution function, the second predicted probability distribution function, the predicted object type, the predicted object attribute, the labeled object type, and the labeled object attribute; and
adjusting the initial multimedia recognition model based on the first total prediction error, to obtain the target multimedia recognition model.

That the processor 1001 may be configured to invoke the device control application program stored in the memory 1005, to determine the first total prediction error of the initial multimedia recognition model based on the first predicted probability distribution function, the second predicted probability distribution function, the predicted object type, the predicted object attribute, the labeled object type, and the labeled object attribute includes:
determining a total predicted probability distribution function of the initial multimedia recognition model based on the first predicted probability distribution function and the second predicted probability distribution function, where the total predicted probability distribution function is configured for reflecting probability distribution of the predicted object type and the predicted object attribute that are simultaneously outputted by the initial multimedia recognition model;
performing maximum likelihood solving on the total predicted probability distribution function, to construct a maximum likelihood function of the initial multimedia recognition model; and
obtaining, through calculation, the first total prediction error of the initial multimedia recognition model based on the maximum likelihood function, the predicted object type, the predicted object attribute, the labeled object type, and the labeled object attribute.

That the processor 1001 may be configured to invoke the device control application program stored in the memory 1005, to obtain, through calculation, the first total prediction error of the initial multimedia recognition model based on the maximum likelihood function, the predicted object type, the predicted object attribute, the labeled object type, and the labeled object attribute includes:
obtaining a cross-entropy function for describing a difference between the predicted object type and the labeled object type, and a mean-square error function for describing a difference between the labeled object attribute and the predicted object attribute;
adjusting the maximum likelihood function of the initial multimedia recognition model based on the cross-entropy function and the mean-square error function, to determine a total loss function of the initial multimedia recognition model; and
substituting the predicted object type, the predicted object attribute, the labeled object type, and the labeled object attribute into the total loss function, to obtain, through calculation, the first total prediction error of the initial multimedia recognition model.

That the processor 1001 may be configured to invoke the device control application program stored in the memory 1005, to adjust the initial multimedia recognition model based on the first total prediction error, to obtain the target multimedia recognition model includes:
if the first total prediction error is greater than an error threshold, adjusting the initial multimedia recognition model based on the first total prediction error, where the error threshold is obtained through calculation based on the total loss function; and
when a first total prediction error of an adjusted initial multimedia recognition model is less than the error threshold, determining, as the target multimedia recognition model, the adjusted initial multimedia recognition model whose first total prediction error is less than the error threshold.

That the processor 1001 may be configured to invoke the device control application program stored in the memory 1005, to adjust the initial multimedia recognition model based on the predicted object type, the predicted object attribute, the labeled object type, and the labeled object attribute, to obtain the target multimedia recognition model includes:
determining an object-type prediction error of the initial multimedia recognition model based on the predicted object type and the labeled object type;
determining an object-attribute prediction error of the initial multimedia recognition model based on the predicted object attribute and the labeled object attribute; and
adjusting the initial multimedia recognition model based on the object-type prediction error and the object-attribute prediction error, to obtain the target multimedia recognition model.

That the processor 1001 may be configured to invoke the device control application program stored in the memory 1005, to adjust the initial multimedia recognition model based on the object-type prediction error and the object-attribute prediction error, to obtain the target multimedia recognition model includes:
generating a second total prediction error of the initial multimedia recognition model based on the object-type prediction error and the object-attribute prediction error; and
adjusting the initial multimedia recognition model based on the second total prediction error, to obtain the target multimedia recognition model.

That the processor 1001 may be configured to invoke the device control application program stored in the memory 1005, to adjust the initial multimedia recognition model based on the second total prediction error, to obtain the target multimedia recognition model includes:
performing verification on a state of the initial multimedia recognition model based on the second total prediction error, to obtain a verification result;
if the verification result indicates that the initial multimedia recognition model is in a non-converged state, adjusting the initial multimedia recognition model based on the total prediction error until an adjusted initial multimedia recognition model is in a converged state; and
determining the adjusted initial multimedia recognition model in the converged state as the target multimedia recognition model.

The processor 1001 may be configured to invoke the device control application program stored in the memory 1005, to perform object-type recognition on the target multimedia data by using the target multimedia recognition model, to obtain an initial object type of the object in the target multimedia data, and an object-type recognition deviation of the target multimedia recognition model for the target multimedia data;
perform object-attribute recognition on the target multimedia data by using the target multimedia recognition model, to obtain an initial object attribute of the object in the target multimedia data, and an object-attribute recognition deviation of the target multimedia recognition model for the target multimedia data;
correct the initial object type based on the object-type recognition deviation, to obtain the target object type of the object in the target multimedia data; and
correct the initial object attribute based on the object-attribute recognition deviation, to obtain the target object attribute of the object in the target multimedia data.

In the embodiments of this application, in a process of training the initial multimedia recognition model, the object-type prediction deviation and the object-attribute prediction deviation that are of the initial multimedia recognition model are introduced, and the initial object type is corrected based on the object-type recognition deviation, to obtain the predicted object type of the sample object. In this way, accuracy of the object type predicted by the initial multimedia recognition model can be improved, to help improve a difference degree between object types of different sample objects. The initial object attribute is corrected based on the object-attribute prediction deviation, to obtain the predicted object attribute of the sample object. In this way, accuracy of the object attribute predicted by the initial multimedia recognition model can be improved, to help improve a difference degree between object attributes of different sample objects. Further, the initial multimedia recognition model is adjusted based on the predicted object type, the predicted object attribute, the labeled object type, and the labeled object attribute, to obtain the target multimedia recognition model configured for recognizing the target object type and the target object attribute that are of the object in the target multimedia data. In other words, when the initial multimedia recognition model is trained to fit the labeled object type and the labeled object attribute of the sample object, prediction errors of the initial multimedia recognition model for the two types of tasks are reduced, to improve media recognition accuracy and a generalization capability of the multimedia recognition model.

The computer device described in the embodiments of this application may perform the foregoing descriptions of the foregoing multimedia data processing method in the embodiment corresponding to FIG. 4A, FIG. 4B, or FIG. 5, or may perform the foregoing descriptions of the foregoing multimedia data processing apparatus in the embodiment corresponding to FIG. 7. Details are not described herein again. In addition, for descriptions of beneficial effects of using the same method, details are not described herein again.

In addition, an embodiment of this application further provides a non-transitory computer-readable storage medium. The computer-readable storage medium stores a computer program executed by the foregoing multimedia data processing apparatus, and the computer program includes program instructions. When executing the foregoing program instructions, the processor can perform the foregoing descriptions of the foregoing multimedia data processing method in the embodiment corresponding to FIG. 4A, FIG. 4B, or FIG. 5. Therefore, details are not described herein again. In addition, for descriptions of beneficial effects of using the same method, details are not described herein again. For technical details not disclosed in the embodiment of the computer-readable storage medium involved in this application, refer to the descriptions of the method embodiments of this application.

In an example, the program instructions may be deployed in a computer device for execution, or deployed in at least two computer devices at one location for execution, or distributed in at least two computer devices at at least two locations and connected via a communication network. The at least two computer devices at the at least two locations and connected via the communication network may form a blockchain network.

The foregoing computer-readable storage medium may be an intermediate storage unit in the multimedia data processing apparatus provided in any one of the foregoing embodiments or the foregoing computer device, for example, a hard disk or an internal memory in the computer device. The computer-readable storage medium may alternatively be an external storage device of the computer device, for example, a plug-in hard disk disposed in the computer device, a smart memory card (SMC), a security digital (SD) card, or a flash card. Further, the computer-readable storage medium may alternatively include both an intermediate storage unit and an external storage device of the computer device. The computer-readable storage medium is configured to store a computer program and another program and data required by the computer device. The computer-readable storage medium may be further configured to temporarily store data that has been outputted or that is to be outputted.

The terms “first”, “second”, and the like in the specification, the claims, and the accompanying drawings of the embodiments of this application are intended to distinguish between different media content, instead of describing a particular sequence. In addition, the term “including”, or any other variant thereof is intended to cover a non-exclusive inclusion. For example, a process, a method, an apparatus, a product, or a device including a series of steps or units is not limited to the listed steps or modules, but instead, in some embodiments, includes steps or modules that are not listed, or in some embodiments, includes other steps or units inherent to the process, method, apparatus, product, or device.

In the foregoing embodiments of this application, if user information and the like need to be used, user permission or consent needs to be obtained, and relevant laws and regulations of relevant countries and regions need to be complied with.

An embodiment of this application further provides a computer program product, including a computer program/instructions. When the computer program/instructions are executed by a processor, the foregoing descriptions of the foregoing multimedia data processing method in the embodiment corresponding to FIG. 4A, FIG. 4B, or FIG. 5 are implemented. Therefore, details are not described herein again. In addition, for descriptions of beneficial effects of using the same method, details are not described herein again. For technical details not disclosed in the embodiment of the computer program product involved in this application, refer to the descriptions of the method embodiments of this application.

A person of ordinary skill in the art may be aware that, in combination with the examples described in the embodiments disclosed in this specification, units and algorithm steps may be implemented by electronic hardware or a combination of computer software and electronic hardware. To clearly describe interchangeability between the hardware and the software, compositions and operations of each example are generally described in the foregoing descriptions based on functions. Whether the functions are executed by hardware or software depends on particular applications and design constraint conditions of the technical solutions. A person skilled in the art may implement the described function by using different methods for each particular application, but such implementation is not to be considered to go beyond the scope of this application.

The method and the related apparatus provided in the embodiments of this application are described with reference to the method flowcharts and/or the schematic diagrams of the structures provided in the embodiments of this application. Specifically, each procedure and/or block in the method flowcharts and/or the schematic diagrams of the structures and a combination of a procedure and/or a block in the flowcharts and/or the block diagrams may be implemented by using computer program instructions. The computer program instructions may be provided to a general-purpose computer, a dedicated computer, an embedded processing machine, or a processor of another programmable network connection device, to generate a machine, so that the instructions executed by the computer or the processor of the another programmable network connection device generate an apparatus configured to implement the functions specified in one or more processes of the flowcharts and/or one or more blocks of the schematic diagrams of the structures. The computer program instructions may alternatively be stored in a computer-readable memory that can guide a computer or another programmable network connection device to operate in a specific manner, so that the instructions stored in the computer-readable memory generate an artifact including an instruction apparatus. The instruction apparatus implements the functions specified in one or more processes of the flowcharts and/or one or more blocks of the schematic diagrams of the structures. The computer program instructions may alternatively be loaded onto a computer or another programmable network connection device, so that a series of operations are performed on the computer or the another programmable device to generate processing implemented by a computer. Therefore, the instructions executed on the computer or the another programmable device provide operations for implementing the functions specified in one or more processes of the flowcharts and/or one or more blocks of the schematic diagrams of the structures.

What is claimed is:

1. A multimedia data processing method performed by a computer device, the method comprising:
obtaining sample multimedia data, and a labeled object type and a labeled object attribute of a sample object in the sample multimedia data;
predicting an object type and an object attribute of the sample object by applying the sample multimedia data to an initial multimedia recognition model; and
adjusting the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute of an object in target multimedia data.

2. The method according to claim 1, wherein the method further comprises:
determining an object-type prediction deviation of the initial multimedia recognition model for the sample multimedia data and an object-attribute prediction deviation of the initial multimedia recognition model for the sample multimedia data; and
correcting the predicted object type based on the object-type prediction deviation and the predicted object attribute based on the object-attribute prediction deviation, respectively.

3. The method according to claim 2, wherein the correcting the predicted object type based on the object-type prediction deviation and the predicted object attribute based on the object-attribute prediction deviation comprises:
determining a first distribution feature of the predicted object type and a second distribution feature of the predicted object attribute;
correcting the predicted object type based on the first distribution feature and the object-type prediction deviation; and
correcting the predicted object attribute based on the second distribution feature and the object-attribute prediction deviation.

4. The method according to claim 1, wherein the adjusting the initial multimedia recognition model based on the predicted object type, the predicted object attribute, the labeled object type, and the labeled object attribute, to obtain a target multimedia recognition model comprises:
selecting, based on a distribution feature of the predicted object type, a first predicted probability distribution function corresponding to the predicted object type;
selecting, based on a distribution feature of the predicted object attribute, a second predicted probability distribution function corresponding to the predicted object attribute;
determining a first total prediction error of the initial multimedia recognition model based on the first predicted probability distribution function, the second predicted probability distribution function, the predicted object type, the predicted object attribute, the labeled object type, and the labeled object attribute; and
adjusting the initial multimedia recognition model based on the first total prediction error, to obtain the target multimedia recognition model.

5. The method according to claim 4, wherein the determining a first total prediction error of the initial multimedia recognition model based on the first predicted probability distribution function, the second predicted probability distribution function, the predicted object type, the predicted object attribute, the labeled object type, and the labeled object attribute comprises:
determining a total predicted probability distribution function of the initial multimedia recognition model based on the first predicted probability distribution function and the second predicted probability distribution function, wherein the total predicted probability distribution function is configured for reflecting probability distribution of the predicted object type and the predicted object attribute that are simultaneously outputted by the initial multimedia recognition model;
performing maximum likelihood solving on the total predicted probability distribution function, to construct a maximum likelihood function of the initial multimedia recognition model; and
obtaining, through calculation, the first total prediction error of the initial multimedia recognition model based on the maximum likelihood function, the predicted object type, the predicted object attribute, the labeled object type, and the labeled object attribute.

6. The method according to claim 1, wherein the adjusting the initial multimedia recognition model based on the predicted object type, the predicted object attribute, the labeled object type, and the labeled object attribute, to obtain a target multimedia recognition model comprises:
determining an object-type prediction error of the initial multimedia recognition model based on the predicted object type and the labeled object type;
determining an object-attribute prediction error of the initial multimedia recognition model based on the predicted object attribute and the labeled object attribute; and
adjusting the initial multimedia recognition model based on the object-type prediction error and the object-attribute prediction error, to obtain the target multimedia recognition model.

7. The method according to claim 1, wherein the method further comprises:
predicting an object type and an object attribute of an object by applying the target multimedia data to the target multimedia recognition model;
correcting the predicted object type based on the object-type recognition deviation, to obtain the target object type of the object in the target multimedia data; and
correcting the predicted object attribute based on the object-attribute recognition deviation, to obtain the target object attribute of the object in the target multimedia data.

8. A computer device, comprising a memory and a processor, the memory having a computer program stored therein that, when executed by the computer device, causing the computer device to perform a multimedia data processing method including:
obtaining sample multimedia data, and a labeled object type and a labeled object attribute of a sample object in the sample multimedia data;
predicting an object type and an object attribute of the sample object by applying the sample multimedia data to an initial multimedia recognition model; and
adjusting the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute of an object in target multimedia data.

9. The computer device according to claim 8, wherein the method further comprises:
determining an object-type prediction deviation of the initial multimedia recognition model for the sample multimedia data and an object-attribute prediction deviation of the initial multimedia recognition model for the sample multimedia data; and
correcting the predicted object type based on the object-type prediction deviation and the predicted object attribute based on the object-attribute prediction deviation, respectively.

10. The computer device according to claim 9, wherein the correcting the predicted object type based on the object-type prediction deviation and the predicted object attribute based on the object-attribute prediction deviation comprises:
determining a first distribution feature of the predicted object type and a second distribution feature of the predicted object attribute;
correcting the predicted object type based on the first distribution feature and the object-type prediction deviation; and
correcting the predicted object attribute based on the second distribution feature and the object-attribute prediction deviation.

11. The computer device according to claim 8, wherein the adjusting the initial multimedia recognition model based on the predicted object type, the predicted object attribute, the labeled object type, and the labeled object attribute, to obtain a target multimedia recognition model comprises:
selecting, based on a distribution feature of the predicted object type, a first predicted probability distribution function corresponding to the predicted object type;
selecting, based on a distribution feature of the predicted object attribute, a second predicted probability distribution function corresponding to the predicted object attribute;
determining a first total prediction error of the initial multimedia recognition model based on the first predicted probability distribution function, the second predicted probability distribution function, the predicted object type, the predicted object attribute, the labeled object type, and the labeled object attribute; and
adjusting the initial multimedia recognition model based on the first total prediction error, to obtain the target multimedia recognition model.

12. The computer device according to claim 11, wherein the determining a first total prediction error of the initial multimedia recognition model based on the first predicted probability distribution function, the second predicted probability distribution function, the predicted object type, the predicted object attribute, the labeled object type, and the labeled object attribute comprises:
determining a total predicted probability distribution function of the initial multimedia recognition model based on the first predicted probability distribution function and the second predicted probability distribution function, wherein the total predicted probability distribution function is configured for reflecting probability distribution of the predicted object type and the predicted object attribute that are simultaneously outputted by the initial multimedia recognition model;
performing maximum likelihood solving on the total predicted probability distribution function, to construct a maximum likelihood function of the initial multimedia recognition model; and
obtaining, through calculation, the first total prediction error of the initial multimedia recognition model based on the maximum likelihood function, the predicted object type, the predicted object attribute, the labeled object type, and the labeled object attribute.

13. The computer device according to claim 8, wherein the adjusting the initial multimedia recognition model based on the predicted object type, the predicted object attribute, the labeled object type, and the labeled object attribute, to obtain a target multimedia recognition model comprises:
determining an object-type prediction error of the initial multimedia recognition model based on the predicted object type and the labeled object type;
determining an object-attribute prediction error of the initial multimedia recognition model based on the predicted object attribute and the labeled object attribute; and
adjusting the initial multimedia recognition model based on the object-type prediction error and the object-attribute prediction error, to obtain the target multimedia recognition model.

14. The computer device according to claim 8, wherein the method further comprises:
predicting an object type and an object attribute of an object by applying the target multimedia data to the target multimedia recognition model;
correcting the predicted object type based on the object-type recognition deviation, to obtain the target object type of the object in the target multimedia data; and
correcting the predicted object attribute based on the object-attribute recognition deviation, to obtain the target object attribute of the object in the target multimedia data.

15. A non-transitory computer-readable storage medium, having a computer program stored therein that, when executed by a processor of a computer device, causing the computer device to perform a multimedia data processing method including:
obtaining sample multimedia data, and a labeled object type and a labeled object attribute of a sample object in the sample multimedia data;
predicting an object type and an object attribute of the sample object by applying the sample multimedia data to an initial multimedia recognition model; and
adjusting the initial multimedia recognition model based on the predicted object type, the predicted object attribute, the labeled object type, and the labeled object attribute, to obtain a target multimedia recognition model, the target multimedia recognition model being configured for recognizing a target object type and a target object attribute of an object in target multimedia data.

16. The non-transitory computer-readable storage medium according to claim 15, wherein the method further comprises:
determining an object-type prediction deviation of the initial multimedia recognition model for the sample multimedia data and an object-attribute prediction deviation of the initial multimedia recognition model for the sample multimedia data; and
correcting the predicted object type based on the object-type prediction deviation and the predicted object attribute based on the object-attribute prediction deviation, respectively.

17. The non-transitory computer-readable storage medium according to claim 16, wherein the correcting the predicted object type based on the object-type prediction deviation and the predicted object attribute based on the object-attribute prediction deviation comprises:
determining a first distribution feature of the predicted object type and a second distribution feature of the predicted object attribute;
correcting the predicted object type based on the first distribution feature and the object-type prediction deviation; and
correcting the predicted object attribute based on the second distribution feature and the object-attribute prediction deviation.

18. The non-transitory computer-readable storage medium according to claim 15, wherein the adjusting the initial multimedia recognition model based on the predicted object type, the predicted object attribute, the labeled object type, and the labeled object attribute, to obtain a target multimedia recognition model comprises:
selecting, based on a distribution feature of the predicted object type, a first predicted probability distribution function corresponding to the predicted object type;
selecting, based on a distribution feature of the predicted object attribute, a second predicted probability distribution function corresponding to the predicted object attribute;
determining a first total prediction error of the initial multimedia recognition model based on the first predicted probability distribution function, the second predicted probability distribution function, the predicted object type, the predicted object attribute, the labeled object type, and the labeled object attribute; and
adjusting the initial multimedia recognition model based on the first total prediction error, to obtain the target multimedia recognition model.

19. The non-transitory computer-readable storage medium according to claim 15, wherein the adjusting the initial multimedia recognition model based on the predicted object type, the predicted object attribute, the labeled object type, and the labeled object attribute, to obtain a target multimedia recognition model comprises:
determining an object-type prediction error of the initial multimedia recognition model based on the predicted object type and the labeled object type;
determining an object-attribute prediction error of the initial multimedia recognition model based on the predicted object attribute and the labeled object attribute; and
adjusting the initial multimedia recognition model based on the object-type prediction error and the object-attribute prediction error, to obtain the target multimedia recognition model.

20. The non-transitory computer-readable storage medium according to claim 15, wherein the method further comprises:
predicting an object type and an object attribute of an object by applying the target multimedia data to the target multimedia recognition model;
correcting the predicted object type based on the object-type recognition deviation, to obtain the target object type of the object in the target multimedia data; and
correcting the predicted object attribute based on the object-attribute recognition deviation, to obtain the target object attribute of the object in the target multimedia data.
